(19) United States
(12) Patent Application Publication
(10) Pub. No.: US 2026/0011713 A1
(43) Pub. Date: Jan. 8, 2026

(54) LITHIUM-ION SECONDARY BATTERY

(71) Applicant: SEMICONDUCTOR ENERGY LABORATORY CO., LTD., Atsugi-shi (JP)

(72) Inventors: Ryo NARUKAWA, Hadano (JP); Kanta ABE, Atsugi (JP); Yohei MOMMA, Isehara (JP); Mayumi MIKAMI, Atsugi (JP); Tatsuyoshi TAKAHASHI, Atsugi (JP); Kazuki TANEMURA, Isehara (JP); Tomoya KAMIKOCHI, Atsugi (JP)

(21) Appl. No.: 19/247,668

(22) Filed: Jun. 24, 2025

(30) Foreign Application Priority Data
Jul. 5, 2024 (JP) 2024-108914

(51) Int. Cl. H01M 4/36; H01M 4/02; H01M 4/38; H01M 4/46

(52) U.S. Cl. CPC H01M 4/362; H01M 4/382; H01M 4/463; H01M 2004/021; H01M 2004/028

(57) ABSTRACT

A lithium-ion secondary battery with high discharge capacity and favorable rate characteristics is provided. The lithium-ion secondary battery includes a positive electrode, a negative electrode, and a first electrolyte solution, in which the positive electrode includes a positive electrode active material; the positive electrode active material has an olivine crystal structure and includes lithium, manganese, iron, aluminum, phosphorus, and oxygen; an atomic ratio of manganese to the sum of manganese, iron, and aluminum (Mn/(Mn+Fe+Al)) in the positive electrode active material is greater than 0.5; and an atomic ratio of aluminum to the sum of manganese, iron, and aluminum (Al/(Mn+Fe+Al)) in the positive electrode active material is greater than or equal to 0.01 and less than 0.1.

### BACKGROUND OF THE INVENTION

### 1. Field of the Invention

One embodiment of the present invention relates to an object, a method, or a manufacturing method. The present invention relates to a process, a machine, manufacture, or a composition of matter. One embodiment of the present invention relates to a power storage device, a semiconductor device, a display device, a light-emitting device, a lighting device, an electronic device each including a secondary battery, or a manufacturing method thereof. Another embodiment of the present invention relates to a secondary battery and a device that can be used as a material of an active material included in the secondary battery or a manufacturing method thereof.

Note that electronic devices in this specification mean all devices including power storage devices, and electro-optical devices including power storage devices, information terminal devices including power storage devices, and the like are all electronic devices.

### 2. Description of the Related Art

In recent years, a variety of power storage devices, such as lithium-ion secondary batteries, lithium-ion capacitors, and air batteries, have been actively developed. In particular, demand for lithium-ion secondary batteries with high output and high energy density has rapidly grown with the development of the semiconductor industry, for portable information terminals typified by mobile phones, smartphones, or laptop computers, portable music players, digital cameras, medical equipment, and next-generation clean energy vehicles typified by hybrid electric vehicles (HVs), electric vehicles (EVs), and plug-in hybrid electric vehicles (PHVs), and the lithium-ion secondary batteries are essential as rechargeable energy supply sources for today's information society.

LiMPO₄ having an olivine crystal structure (M is Fe, Mn, Ni, or Co) is one of the materials that are expected to be positive electrode active materials of lithium-ion secondary batteries and have been extensively researched and developed. Among the materials, LiFePO₄ has already achieved charge and discharge capacity close to the theoretical capacity of 168 mAh/g (e.g., Non-Patent Document 1), and a secondary battery using LiFePO₄ is mounted on an EV or the like. LiFePO₄ has excellent charge and discharge cycle performance and high thermal stability. In addition, a large number of researches have been conducted on the charge and discharge mechanism of LiFePO₄ (e.g., Non-Patent Document 2).

### REFERENCES

### Non-Patent Documents

[Non-Patent Document 1] A.Yamada, S.C.Chung and K.Hinokuma, “Optimized LiFePO₄ for Lithium Battery Cathodes”, J.Electrochem.Soc., 148, A224-229 (2001).
[Non-Patent Document 2] Delmas, C., Maccario,M., Croguennec,L. et al. “Lithium deintercalation in LiFePO₄ nanoparticles via a domino-cascade model.” Nature Mater 7, 665-671 (2008).

### Patent Document

[Patent Document 1] Japanese Published Patent Application No. 2011-222494

### SUMMARY OF THE INVENTION

However, LiFePO₄ has an energy density per weight of the positive electrode active material of 578 Wh/kg, which is lower than that of a positive electrode active material of another commercially available lithium-ion secondary battery.

Since exhibiting a higher oxidation-reduction potential than LiFePO₄, LiMnPO₄ is expected to achieve further increased energy density. A material such as LiMnₓFe₁₋ₓPO₄(0<x<1)(e.g., LiMn_{0.5}Fe_{0.5}PO₄), which is a solid solution of LiMnPO₄ and LiFePO₄, has also been examined (Patent Document 1).

However, LiMnPO₄ and LiMnₓFe₁₋ₓPO₄ (0<x<1) have problems such as lower conductivity than LiFePO₄ and a lower lithium ion diffusion coefficient in a solid than LiFePO₄. Thus, the charge and discharge capacity of LiMnPO₄ and LiMnₓFe₁₋ₓPO₄ is sometimes smaller than a theoretically expected value. Another problem is that the charge and discharge capacity of LiMnPO₄ and LiMnₓFe₁₋ₓPO₄ decreases at a high rate or at a low temperature (e.g., lower than or equal to 0° C.). For example, in the case where LiMnPO₄ and LiMnₓFe₁₋ₓPO₄ are used for an EV, the mileage of the EV may be shortened due to insufficient charge and discharge capacity. Besides, the EV cannot be sufficiently accelerated if the discharge capacity at a high rate is insufficient, and furthermore, the EV cannot be used because of a decrease in the outside temperature if the charge and discharge capacity at a lower temperature than the room temperature is extremely low.

Another problem is that the repeated charge and discharge cycles performed on LiMnPO₄ and LiMnₓFe₁₋ₓPO₄ at high temperatures (e.g., higher than or equal to 45° C. and lower than or equal to 60° C.) hinder a plateau derived from oxidation-reduction of manganese (Mn²⁺/Mn³⁺) from being maintained and thus lower the energy density.

In view of the above, an object of one embodiment of the present invention is to provide a positive electrode active material or a composite oxide with high energy density or a secondary battery using the positive electrode active material or the composite oxide. Another object is to provide a positive electrode active material or a composite oxide with high discharge capacity, or a secondary battery using the positive electrode active material or the composite oxide. Another object is to provide a positive electrode active material or a composite oxide which has a high oxidation-reduction potential and maintains the high oxidation-reduction potential even after a charge and discharge cycle, or a secondary battery using the positive electrode active material or the composite oxide. Another object is to provide a positive electrode active material or a composite oxide which has charge and discharge capacity less likely to decrease at a low temperature, or a secondary battery using the positive electrode active material or the composite oxide. Another object is to provide a positive electrode active material or a composite oxide which has charge and discharge capacity less likely to decrease at a high rate, or a secondary battery using the positive electrode active material or the composite oxide. Another object is to provide a positive electrode active material or a composite oxide which has energy density less likely to decrease at a high temperature, or a secondary battery using the positive electrode active material or the composite oxide. Another object is to provide a secondary battery having favorable electrical characteristics in a wide temperature range. Another object is to provide a secondary battery with high safety or high reliability.

Another object of one embodiment of the present invention is to provide a novel positive electrode active material, a novel composite oxide, a novel power storage device, or a manufacturing method thereof.

Note that the description of these objects does not preclude the existence of other objects. One embodiment of the present invention does not need to achieve all of these objects. Other objects can be derived from the description of the specification, the drawings, and the claims.

To achieve the above objects in one embodiment of the present invention, a small amount of an additive element is added to LiMnₓFe₁₋ₓPO₄(0<x<1) to form a solid solution. The additive element is preferably an element whose trivalent cation is stable, such as aluminum, gallium, indium, scandium, yttrium, antimony, or bismuth. It is also preferable to use an element having a small difference in ion radius with manganese and iron. In particular, aluminum is preferable.

One embodiment of the present invention is a lithium-ion secondary battery including a positive electrode, a negative electrode, and a first electrolyte solution, in which the positive electrode includes a positive electrode active material; the positive electrode active material has an olivine crystal structure and includes lithium, manganese, iron, aluminum, phosphorus, and oxygen; an atomic ratio of manganese to the sum of manganese, iron, and aluminum (Mn/(Mn+Fe+Al)) in the positive electrode active material is greater than 0.5 and less than 0.85; and an atomic ratio of aluminum to the sum of manganese, iron, and aluminum (Al/(Mn+Fe+Al)) in the positive electrode active material is greater than or equal to 0.01 and less than 0.1.

In the above, the olivine crystal structure belongs to a space group Pnma (No. 62). When a powder X-ray diffraction pattern of the positive electrode is subjected to Rietveld analysis with CuKα₁ radiation, an a-axis lattice constant of the olivine crystal structure is preferably greater than or equal to 10.3935 Å and less than or equal to 10.4006 Å, further preferably greater than or equal to 10.3999 Å and less than or equal to 10.4006 Å; a b-axis lattice constant of the olivine crystal structure is preferably greater than or equal to 6.0565 Å and less than or equal to 6.0621 Å, further preferably greater than or equal to 6.0616 Å and less than or equal to 6.0621 Å; and a c-axis lattice constant of the olivine crystal structure is preferably greater than or equal to 4.7218 Å and less than or equal to 4.7221 Å.

In the above, a crystallite size LVol-IB of the olivine crystal structure is preferably greater than or equal to 50 nm and less than 90 nm.

In the above, in the case where a charge and discharge cycle test is performed in a measurement environment at 60° C. on a half cell including the positive electrode and ethylene carbonate, diethyl carbonate, and vinylene carbonate as a second electrolyte solution, a discharge capacity per weight of the positive electrode active material is preferably greater than or equal to 160 mAh/g in the 1st cycle to the 30th cycle. In the charge and discharge test, CCCV charge with a charge current of 85 mA/g, a charge voltage of 4.5 V, a termination current of 8.5 mA/g, and CC discharge with a discharge current of 85 mA/g and a termination voltage of 2.5 V are performed in this order.

According to one embodiment of the present invention, a positive electrode active material or a composite oxide with high energy density or a secondary battery using the positive electrode active material or the composite oxide can be provided. Alternatively, a positive electrode active material or a composite oxide with high discharge capacity, or a secondary battery using the positive electrode active material or the composite oxide can be provided. Alternatively, a positive electrode active material or a composite oxide which has a high oxidation-reduction potential and maintains a high oxidation-reduction potential even after a charge and discharge cycle, or a secondary battery using the positive electrode active material or the composite oxide can be provided. Alternatively, a positive electrode active material or a composite oxide which has charge and discharge capacity less likely to decrease at a low temperature, or a secondary battery using the positive electrode active material or the composite oxide can be provided. Alternatively, a positive electrode active material or a composite oxide which has charge and discharge capacity less likely to decrease at a high rate, or a secondary battery using the positive electrode active material or the composite oxide can be provided. Alternatively, a positive electrode active material or a composite oxide which has energy density less likely to decrease at a high temperature, or a secondary battery using the positive electrode active material or the composite oxide can be provided. Alternatively, a secondary battery having favorable electrical characteristics in a wide temperature range can be provided. Alternatively, a secondary battery with high safety or high reliability can be provided.

According to another embodiment of the present invention, a novel positive electrode active material, a novel composite oxide, a novel power storage device, or a manufacturing method thereof can be provided.

Note that the description of these effects does not preclude the presence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

In the accompanying drawings:

FIGS. 1A to 1D each show a positive electrode active material of one embodiment of the present invention;

FIG. 2 shows an example of a method for manufacturing a positive electrode active material of one embodiment of the present invention;

FIGS. 3A to 3C show a lithium-ion secondary battery of one embodiment of the present invention;

FIGS. 4A to 4C show an electric vehicle of one embodiment of the present invention;

FIGS. 5A to 5E show vehicles or the like of one embodiment of the present invention;

FIGS. 6A to 6D show electronic devices or the like of one embodiment of the present invention;

FIG. 7 shows XRD patterns of a positive electrode active material in Example;

FIG. 8 shows a Rietveld analysis result of an XRD pattern of a positive electrode active material in Example;

FIGS. 9A to 9C are graphs showing lattice constants and aluminum concentrations;

FIG. 10 shows a unit cell of LiMnₓFe₁₋ₓPO₄(0<x<1);

FIGS. 11A and 11B show rate characteristics of half cells in Example;

FIGS. 12A and 12B show charge and discharge cycle performances of half cells in Example;

FIGS. 13A and 13B show charge and discharge cycle performances of half cells in Example;

FIGS. 14A and 14B show charge and discharge curves of half cells in Example;

FIGS. 15A and 15B show dV/dQ curves of half cells in Example; and

FIGS. 16A to 16C show dV/dQ curves of half cells in Example.

### DETAILED DESCRIPTION OF THE INVENTION

Hereinafter, embodiment examples for carrying out the present invention will be described with reference to the drawings and the like. Note that the present invention should not be construed as being limited to the embodiment examples given below. Embodiments for carrying out the invention can be changed unless they deviate from the spirit of the present invention.

In the drawings, sizes, layer thicknesses, or regions are sometimes exaggerated for clarity. Thus, the size, the layer thickness, or the region is not limited to the illustrated scale.

Ordinal numbers such as “first” and “second” in this specification and the like are used in order to avoid confusion among components and do not denote the order such as the order of steps or the stacking order. A term without an ordinal number in this specification and the like might be provided with an ordinal number in a claim in order to avoid confusion among components. A term with an ordinal number in this specification and the like may be described with a different ordinal number in a claim. A term with an ordinal number in this specification and the like may be described without an ordinal number in a claim.

In this specification and the like, a space group is represented using the short symbol of the international notation (or the Hermann-Mauguin notation), and a space group number is sometimes added thereto. Furthermore, the Miller index is used for the expression of crystal planes and crystal orientations. In the crystallography, a bar is placed over a number in the expression of space groups, crystal planes, and crystal orientations; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. Furthermore, even when the same space group number is used, the expression of a space group differs depending on the way of determining a crystal axis in some cases. For example, Pnma (a, b, c), Pmnb (a, b, −c), Pbnm (c, a, b), Pcmn (−c, b, a), Pmcn (b, c, a), and Pnam (a, −c, b) belonging to the space group number 62 have different crystal axes; however, they each represent the same unit cell.

In this specification and the like, description including a simple term “positive electrode active material” explains a plurality of positive electrode active material particles in some cases and explains one positive electrode active material particle in other cases, depending on an analysis method or the like. For example, when description relates to line analysis by a scanning transmission electron microscope and energy dispersive x-ray spectroscopy (STEM-EDX), STEM-electron energy-loss spectroscopy (STEM-EELS), or electron diffraction, the description is made on one positive electrode active material particle unless otherwise specified. Meanwhile, when description relates to X-ray photoelectron spectroscopy (XPS), X-ray diffraction (XRD), various types of mass spectroscopy, or the like, the description is made on a plurality of positive electrode active material particles unless otherwise specified.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape. In addition, a simple term “particle” includes a primary particle and a secondary particle.

In the case where the features of positive electrode active material particles are described, not all the particles necessarily have the features. When 50% or more, preferably 70% or more, further preferably 90% or more of three or more randomly selected particles of a positive electrode active material have the later-described preferable features, for example, it can be said that an effect of improving the characteristics of the positive electrode active material and a secondary battery including the positive electrode active material is sufficiently obtained.

The distribution of an element indicates the region where the element is successively detected by a successive analysis method to the extent that the detection value is no longer on the noise level. The region where the element is successively detected to the extent that the detection value is no longer on the noise level can be rephrased as, for example, the region where the element is detected every time the analysis is performed.

The space group of a crystal structure is identified by XRD, electron diffraction, neutron diffraction, or the like. Thus, in this specification and the like, belonging to a space group or being a space group can be rephrased as being identified as a space group.

Note that the description is made on the assumption that materials (such as a positive electrode active material, a negative electrode active material, an electrolyte, and a separator) of a secondary battery have not deteriorated unless otherwise specified. A decrease in discharge capacity due to aging treatment or the like during the manufacturing process of a secondary battery is not regarded as degradation. For example, a state where discharge capacity is higher than or equal to 97% of the rated capacity of a lithium-ion secondary battery cell and an assembled lithium-ion secondary battery (hereinafter, referred to as a lithium-ion secondary battery) can be regarded as a non-deteriorated state. The rated capacity conforms to Japanese Industrial Standards (JIS C 8711:2019) in the case of a lithium-ion secondary battery for a portable device. The rated capacities of other lithium-ion secondary batteries conform to JIS described above, JIS for electric vehicle propulsion, industrial use, and the like, standards defined by the International Electrotechnical Commission (IEC), and the like.

### Embodiment 1

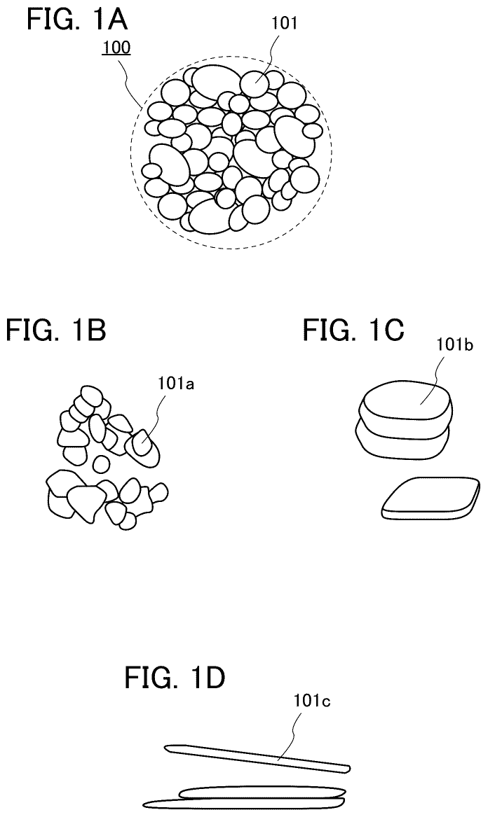

In this embodiment, characteristics of a positive electrode active material 100 of one embodiment of the present invention will be described with reference to FIGS. 1A to 1D.

The positive electrode active material 100 includes lithium, manganese, iron, an additive element, phosphorus, and oxygen. As the additive element, it is preferable to use an element whose trivalent cation is stable when the element forms a solid solution with the positive electrode active material 100. It is also preferable to use an element having a small difference in ion radius with manganese and iron when the element forms a solid solution with the positive electrode active material 100. For example, one or more selected from aluminum, gallium, indium, scandium, yttrium, antimony, and bismuth can be used, and aluminum is particularly preferable. The positive electrode active material 100 has an olivine crystal structure represented by LiMnₓFe₁₋ₓPO₄(0<x<1).

The olivine crystal structure represented by LiMnₓFe₁₋ₓPO₄(0<x<1) is an orthorhombic crystal and belongs to a space group Pnma (No. 62). Oxygen has a hexagonal close-packed structure, lithium, manganese, iron, and magnesium exist in octahedral sites, and phosphorus exists in tetrahedral sites. Note that oxygen has a hexagonal close-packed structure but has distortion compared with an ideal hexagonal close-packed structure. Note that a defect such as a cation or anion vacancy may be present. The composition of the positive electrode active material 100 is not strictly limited to Li: (Mn+Fe+additive element): P:O=1:1:1:4 (atomic ratio).

The atomic ratio of manganese to the sum of manganese, iron, and the additive element included in the positive electrode active material 100 (Mn/(Mn+Fe+additive element)) is preferably greater than 0.5, further preferably greater than or equal to 0.55. The higher the atomic ratio of manganese to the sum of manganese and iron in the positive electrode active material 100 is, the higher the energy density of the secondary battery can be. However, when the atomic ratio of manganese to the sum of manganese and iron is too high, the conductivity or the lithium ion diffusion coefficient might be lowered. Thus, (Mn/(Mn+Fe+additive element)) is preferably less than 0.85 or less than or equal to 0.7 in some cases.

When the positive electrode active material 100 includes a too small amount of the additive element, the effect of increasing the charge and discharge capacity might not be sufficiently exhibited. Furthermore, a decrease in charge and discharge capacity at a high rate or at a low temperature (e.g., lower than or equal to 0° C.) might not be sufficiently inhibited. Note that in this specification and the like, a high rate means that current per weight of the positive electrode active material at 1 C=170 mA/g is higher than or equal to 2 C (340 mA/g), typically 5 C (850 mA/g). A low rate means that current per weight of the positive electrode active material at 1 C=170 mA/g is lower than 2 C (340 mA/g), typically 0.2 C (34 mA/g). A low temperature refers to a temperature lower than or equal to 0° C., typically higher than or equal to −20° C. and lower than or equal to 0° C.

When the amount of the additive element is too small, the effect of maintaining a plateau derived from oxidation-reduction of manganese at high temperatures even after charge and discharge cycles might not be sufficiently exhibited. Note that in this specification and the like, a high temperature is higher than or equal to 45° C. or higher than or equal to 45° C. and lower than or equal to 90° C., typically 60° C. A plateau means a region where voltage is constant regardless of a change in charge and discharge capacity. A plateau derived from oxidation-reduction (Mn²⁺/Mn³⁺) of manganese is affected by internal resistance or the like of a battery but typically appears at higher than or equal to 4.0 V and lower than or equal to 4.2 V (vs Li/Li⁺). Note that a plateau derived from oxidation-reduction (Fe²⁺/Fe³⁺) of iron typically appears at approximately 3.5 V (vs Li/Li⁺).

However, the above additive element such as aluminum can exist stably when having an oxidation number of 0 or 3. Charge compensation for insertion and extraction of lithium, which is a monovalent cation, needs a change in valence of 1; for example, a change in valence between divalent and trivalent is necessary. Accordingly, the above additive element such as aluminum does not contribute to the charge compensation for insertion and extraction of lithium. Thus, a too large amount of the additive elements lowers the charge and discharge capacity. In view of this, the atomic ratio of the additive element to the sum of manganese, iron, and the additive element (the additive element/(Mn+Fe+additive element)) is preferably greater than 0.01 and less than 0.1, further preferably greater than 0.01 and less than 0.05, or can be greater than or equal to 0.015 and less than or equal to 0.025. When the additive element is included in the above range, the positive electrode active material can have high charge and discharge capacity, favorable rate characteristics, and favorable low-temperature characteristics.

Similarly, in the case where aluminum is used as the additive element, the atomic ratio of aluminum (Al/(Mn+Fe+Al)) to the sum of manganese, iron, and aluminum is preferably greater than 0.01 and less than 0.1, further preferably greater than 0.01 and less than 0.05, or can be greater than or equal to 0.015 and less than or equal to 0.025. When aluminum is included in the above range, the positive electrode active material can have high charge and discharge capacity, favorable rate characteristics, and favorable low-temperature characteristics.

At least part of the additive element preferably exists forming a solid solution with the positive electrode active material 100. The lattice constant of the olivine crystal structure depends on the proportion of the solid solution of the additive element. The lattice constant of the olivine crystal structure where the additive element forms the solid solution in the above range is slightly shorter than that of the olivine crystal structure where the additive element does not form a solid solution. The olivine crystal structure of the positive electrode active material 100 including aluminum as the additive element belongs to the space group Pnma (No. 62); when a pattern obtained by a diffraction method is subjected to Rietveld analysis, an a-axis lattice constant is preferably greater than or equal to 10.3935 Å and less than or equal to 10.4006 Å, further preferably greater than or equal to 10.3999 Å and less than or equal to 10.4006 Å. Ab-axis lattice constant is preferably greater than or equal to 6.0565 Å and less than or equal to 6.0621 Å, further preferably greater than or equal to 6.0616 Å and less than or equal to 6.0621 Å. A c-axis lattice constant is preferably greater than or equal to 4.7218 Å and less than or equal to 4.7221 Å.

The lattice constants in the above range indicate that aluminum forms a solid solution in a preferable proportion. The additive element preferably forms a solid solution at Mn/Fe sites of LiMPO₄ (Mis Mn or Fe). Note that in this specification and the like, both manganese and iron are sometimes represented by “Mn/Fe” using a slash as in the case of representing manganese and iron sites in an olivine crystal structure.

It is known that LiFePO₄ having an olivine crystal structure is phase-separated into a crystal structure with lithium inserted and a crystal structure with lithium extracted in charge and discharge. As the phase transition mechanism of these two phases, Non-Patent Document 2 has proposed a domino-cascade model in which a boundary between the two phases moves in the a-axis direction. Thus, a lattice mismatch between the crystal structure with lithium inserted and the crystal structure with lithium extracted is preferably small, and in particular, a lattice mismatch of a plane perpendicular to the a-axis is preferably inhibited, which is advantageous in lithium diffusion.

Since aluminum is a typical element having an oxidation number of 3, the valence does not change due to charge and discharge. Thus, when aluminum forms a solid solution with the positive electrode active material 100, a change in lattice constants in charge and discharge is small. Thus, the lattice mismatch at the interface between the two phases that undergo a phase transition is relieved, which is advantageous in lithium diffusion.

Furthermore, another part of the additive element preferably exists in the surface portion of the positive electrode active material 100 without forming a solid solution with the olivine crystal structure. At this time, it is further preferable that the additive element exist as a phosphoric acid compound such as aluminum phosphate, scandium phosphate, or yttrium phosphate. When part of the additive element exists as a phosphoric acid compound in the surface portion, a side reaction between the positive electrode active material 100 and an electrolyte can be inhibited.

In this specification and the like, the surface portion of the positive electrode active material 100 refers to a region that extends less than or equal to 10 nm from the surface in a perpendicular direction or a substantially perpendicular direction. Note that “substantially perpendicular” refers to a state where an angle is greater than or equal to 80° and less than or equal to 100°. A plane generated by a crack can be considered as a surface. The surface portion can be rephrased as the vicinity of a surface, a region in the vicinity of a surface, or a shell.

Note that manganese and iron in LiMnₓFe₁₋ₓPO₄ (0<x<1) each have divalence; thus, when a trivalent cation as the additive element forms a solid solution with manganese and iron, lithium vacancies might be formed around the additive element. The existence of a small amount of lithium vacancies is expected to promote diffusion of lithium ions in a solid. Consequently, the positive electrode active material 100 can have high conductivity and high charge and discharge capacity.

As described above, it is preferable to use an element whose trivalent cation is stable when the element forms a solid solution with the positive electrode active material 100. In addition to the element, an element having another valence may be used. For example, in addition to aluminum, an element to be a divalent cation such as zinc and magnesium may be used as the additive element. An element that does not have a valence other than a divalent cation, such as zinc and magnesium, easily forms a solid solution with an inner portion and can inhibit a change in the volume of the positive electrode active material 100 due to charge and discharge. When both an element that easily exists in the surface portion, such as aluminum, and an element that does not have a valence other than a divalent cation and easily forms a solid solution with the inner portion are used as the additive elements, a synergistic effect can be expected.

### <<Shape>>

The positive electrode active material 100 is preferably a secondary particle including a plurality of primary particles 101 as shown in FIG. 1A. Note that in this specification and the like, a secondary particle refers to a particle in which a plurality of primary particles aggregate, adhere to each other, and/or are sintered.

The primary particle 101 of the positive electrode active material 100 is preferably a single crystal. For example, in the case where a grain boundary of a primary particle that can be observed with SEM is aligned with an area of a crystal orientation mapping that can be observed by electron backscattering diffraction (EBSD), the primary particle 101 can be determined as having a single crystal.

The positive electrode active materials 100 are preferably coated with carbon, and each primary particle 101 is further preferably coated with carbon. The positive electrode active material 100 coated with carbon can have increased conductivity, so that the resistance of the secondary battery can be suppressed.

Although FIG. 1A shows an example where the primary particle 101 has a spherical shape or a long spherical shape, one embodiment of the present invention is not limited thereto. For example, as shown in FIG. 1B, the positive electrode active material 100 may include a distorted spherical primary particle 101a. As shown in FIG. 1C, the positive electrode active material 100 may include a primary particle 101b having a flat-plate shape or a substantially flat-plate shape. As shown in FIG. 1D, the positive electrode active material 100 may include a needle-like primary particle 101c.

The positive electrode active material 100 preferably has a small crystallite size to reduce the diffusion resistance of lithium. For example, the olivine crystal structure of the positive electrode active material 100 preferably has a crystallite size greater than or equal to 50 nm and less than or equal to 90 nm when a pattern obtained by a diffraction method is subjected to Rietveld analysis.

### <<Charge and Discharge Capacity>>

The additive element described above improves the charge and discharge characteristics of the positive electrode active material 100, so that a secondary battery including the positive electrode active material 100 has high charge and discharge capacity. Moreover, a plateau derived from oxidation-reduction of manganese is easily maintained even after charge and discharge cycles. These materials are particularly effective in a charge and discharge cycle test at a high temperature.

For example, the secondary battery including the positive electrode active material 100 preferably has a discharge capacity per weight of the positive electrode active material of greater than or equal to 160 mAh/g in the 1st cycle to the 30th cycle in a charge and discharge cycle test in a measurement environment at 60° C.

In this case, for example, a lithium salt and an electrolyte solution can be formed by adding 2 wt % of vinylene carbonate (VC) to ethylene carbonate (EC): diethyl carbonate (DEC)=3:7 (volume ratio) including 1 mol/dm³ of LiPF₆. The charge and discharge cycle test can be performed by CCCV charge (4.5 V, 85 mA/g, and termination current of 8.5 mA/g) and CC discharge (85 mA/g and termination voltage of 2.5 V) with a break between the charge and the discharge for 10 minutes.

When the plateau derived from oxidation-reduction of manganese is maintained, a positional change of a peak appearing in the range from greater than or equal to 25 mAh/g to less than or equal to 125 mAh/g in the discharge dV/dQ curve with the discharge capacity on the horizontal axis is small. Thus, a change in energy density is small. In other words, when the amount of plateau derived from oxidation-reduction of manganese decreases, a peak appears on the lower capacity side in the range from greater than or equal to 25 mAh/g to less than or equal to 125 mAh/g. A decrease in the plateau derived from oxidation-reduction of manganese means a decrease in average discharge voltage and a decrease in energy density. Note that although peaks also appear in a range of less than or equal to 25 mAh/g and a range of greater than or equal to 125 mAh/g, the peaks do not relate to the plateau derived from oxidation-reduction of manganese. The dV/dQ curve will be described later.

When a charge and discharge cycle test is performed on the secondary battery including the positive electrode active material 100 in a measurement environment at 60° C., the discharge dV/dQ curves in the range from greater than or equal to 25 mAh/g to less than or equal to 125 mAh/g preferably have the following feature: a difference Peak (1)-Peak (100) in discharge capacity between a position Peak (1) at which the peak of the discharge dV/dQ curve in the 1st cycle appears and a position Peak (100) at which the peak of the discharge dV/dQ curve in the 100th cycle appears is less than or equal to 15 mAh/g.

Similarly, when a charge and discharge cycle test is performed on the secondary battery including the positive electrode active material 100 in a measurement environment at 25° C., the discharge dV/dQ curves in the range greater than or equal to 25 mAh/g to less than or equal to 125 mAh/g preferably have the following feature: the difference Peak (1)-Peak (100) in discharge capacity between the position Peak (1) at which the peak of the discharge dV/dQ curve in the 1st cycle appears and the position Peak (100) at which the peak of the discharge dV/dQ curve in the 100th cycle appears is less than or equal to 7 mAh/g.

In this case, for example, a lithium salt and an electrolyte solution can be formed by adding 2 wt % of vinylene carbonate (VC) to ethylene carbonate (EC): diethyl carbonate (DEC)=3:7 (volume ratio) including 1 mol/dm³ LiPF₆. The charge and discharge cycle test can be performed by CCCV charge (4.5 V, 85 mA/g, and termination current of 8.5 mA/g) and CC discharge (85 mA/g and termination voltage of 2.5 V) with a break between the charge and the discharge for 10 minutes.

Note that in this specification and the like, the number of cycles does not strictly indicate the number of times of charge and discharge after the manufacture of the secondary battery. When the secondary battery is before deterioration, counting the number of cycles can be started at a given timing. Thus, for example, after aging treatment with several times of charge and discharge is performed, the charge and discharge cycle test under the above-described conditions can be started, and the 1st cycle of the charge and discharge cycle test under the above-described conditions can be counted as the 1st cycle.

### <<Rate Characteristics>>

Although the discharge capacity generally decreases at a high rate, the additive element described above improves the rate characteristics of the positive electrode active material 100; thus, a secondary battery including the positive electrode active material 100 has a small difference between battery characteristics at a low rate (typically, 0.2 C and 34 mA/g) and battery characteristics at a high rate (typically, 5 C and 850 mA/g), e.g., a difference in discharge capacity. Note that the rate where the positive electrode active material 100 exhibits effectiveness of the improvement in rate characteristics is not limited to 5 C; for example, the battery characteristics are expected to be favorable also in charge and discharge with current higher than 0.2 C and lower than 5 C or current higher than 5 C.

For example, when the secondary battery including the positive electrode active material 100 is tested in a measurement environment at 25° C., a difference between the discharge capacity in the 0.2 C discharge test and the discharge capacity in the 5 C discharge test is preferably less than or equal to 18.5 mA/g. Alternatively, the discharge capacity ratio is preferably higher than or equal to 88%.

In this case, for example, a lithium salt and an electrolyte solution can be formed by adding vinylene carbonate (VC) at 2 wt % to ethylene carbonate (EC): diethyl carbonate (DEC)=3:7 (volume ratio) including 1 mol/dm³ of LiPF₆. A rate characteristic test can be performed by CCCV charge (constant current and constant voltage) (charge current of 34 mA/g, charge voltage of 4.5 V, and termination current of 3.4 mA/g) and CC discharge (termination voltage of 2.5 V and given discharge current), with a break between the charge and the discharge for 10 minutes. The given discharge current can be set in the order of 34 mA/g (0.2 C), 34 mA/g (0.2 C), 34 mA/g (0.2C), 85 mA/g (0.5 C), 170 mA/g (1 C), 340 mA/g (2 C), 510 mA/g (3 C), 680 mA/g (4 C), 850 mA/g (5 C), and 34 mA/g (0.2 C).

### <<Low-Temperature Characteristics>>

As a result of an improvement in low-temperature characteristics of the positive electrode active material 100 owing to the effect of the additive element, the secondary battery including the positive electrode active material 100 has a small difference between the battery characteristics at 25° C. and the battery characteristics at a low temperature. Note that the temperature range where the positive electrode active material 100 exhibits effectiveness of suppression of degradation of battery characteristics is not limited to higher than or equal to −20° C. and lower than or equal to 0° C.; for example, the battery characteristics such as charge and discharge capacity and rate characteristics are expected to be favorable also at a temperature higher than or equal to 0° C. and lower than 25° C.

<<Charge and Discharge Curve and dV/dQ Curve>>

The positive electrode active material 100 of one embodiment of the present invention sometimes has a characteristic change in charge and discharge voltage. The voltage change can be read from a Q-dQ/dV charge curve and a Q-dQ/dV discharge curve, which can be obtained by differentiating voltage (V) in a charge and discharge curve with capacitance (Q) (dV/dQ). The oxidation-reduction potential differs before and after a peak in these dQ/dV curves. It is probable that a change in the kind of the transition metal that is oxidized or reduced along with insertion and extraction of lithium ions, a change in the level of a crystal phase, and/or the like occur(s) before and after the peak.

In practice, dV/dQ curves are calculated by approximated calculation using numerical differentiation because of a finite resolution of a measurement apparatus, for example. The dV/dQ curve requires data on voltage and current in charge and discharge. There is no particular limitation on a method and an apparatus for obtaining measurement data; for example, charge can be traced only when voltage is risen from a value traced last time, and discharge can be traced only when voltage is dropped from a value traced last time. Such a data obtaining method can use measurement data obtained by constant current (CC) charge and CC discharge and reduce noise; thus, approximated calculation using numerical differentiation can be performed appropriately. A value obtained by multiplying a current value by time in charge is referred to as charge capacity, and a similar value in discharge is referred to as discharge capacity.

In the approximated calculation, the ratio of the average value of voltage to the amount of change is calculated using n sequential pieces of measurement data, and this sequence is used as the approximate data. At this time, n is the number of averaging processes.

As the number of averaging processes increases, noise due to the resolution of a measurement apparatus can be reduced, which is effective particularly when the charge and discharge rate is low. On the other hand, when the number of averaging processes is too large, there are disadvantages such as the numerical differential value not being able to represent the ratio of the amount of local change and the average voltage value becoming separated from reality. Thus, the number of averaging processes is preferably greater than or equal to 1 and less than or equal to 32. Unless otherwise specified in this specification and the like, the number of averaging processes is 8.

Note that a peak in a dV/dQ curve might appear also by a change in another component of a secondary battery, e.g., a structural change of a negative electrode or decomposition of an electrolyte solution. Thus, it is preferable to check the structural change of the negative electrode, the voltage at which the decomposition of the electrolyte solution starts, and/or the like in advance. Furthermore, a half cell including a metal lithium as a counter electrode is further preferably used for the dV/dQ analysis of the positive electrode active material 100.

### <<Analysis>>

### <Composition>

The composition of the positive electrode active material 100 of one embodiment of the present invention can be determined by inductively coupled plasma mass spectrometry (ICP-MS), for example. In addition to ICP-MS, multiple quantitative and semi-quantitative analyses such as a fluorescence X-ray method, a glow discharge mass spectrometry (GD-MS), an energy dispersive

X-ray spectroscopy (EDX), and an electron probe microanalyzer (EPMA) can be combined to evaluate the composition as needed.

### <Elements and Compounds Existing in Surface Portion>

An element existing in the surface portion of the positive electrode active material 100 of one embodiment of the present invention can be detected by an X-ray photoelectron spectroscopy (XPS), an EDX, or the like. The XPS can analyze the chemical bonding state of the element. A peak derived from the compound can be observed by a diffraction method such as XRD when a compound existing in the surface portion has high crystallinity and exists in an amount of approximately 1 wt % or more of the positive electrode active material 100. By combining an analysis of a crystal structure by a diffraction method and an analysis of an element and a chemical bonding state by XPS, EDX, or the like, the compound existing in the surface portion can be identified.

### <Crystallite Size Determined by Diffraction Method>

As described above, the olivine crystal structure of the positive electrode active material 100 preferably has a crystallite size greater than or equal to 50 nm and less than or equal to 90 nm when a pattern obtained by a diffraction method is subjected to Rietveld analysis. Among diffraction methods, X-ray diffraction with CuKα1 radiation, X-ray diffraction with MoKα1 radiation, X-ray diffraction with radiation, neutron diffraction, and the like are preferable because of their high accuracy. Furthermore, the measurement target may be either a powder of the positive electrode active material, or a positive electrode or a secondary battery including the positive electrode active material.

Note that when the positive electrode or the secondary battery is measured, the positive electrode active material might be oriented owing to the influence of pressing in a manufacturing process, for example. Rietveld analysis may have reduced accuracy in the case where the orientation is prominent. Thus, for the analysis of the crystallite size, a diffraction pattern is further preferably obtained by a method that reduces the influence of the orientation: for example, a method of taking out a positive electrode active material layer from a positive electrode, removing a binder or the like in the positive electrode active material layer to some extent using a solvent or the like, and filling the sample holder. Alternatively, when a powder sample is measured, the influence of the orientation may be reduced in the manner where the sample is attached onto a reflection-free silicon plate coated with grease, for example.

The crystallite size can be calculated using ICSD coll. code. 193640 as literature data of lithium ion phosphate and a diffraction pattern that is obtained with Bruker D8 ADVANCE, for example, under the following conditions: CuKα line is used as an X-ray source, the 2θ range is from 15° to 120°, an increment is 0.005, counting time of 1 sec/step, and a detector is LYNXEYE XE-T. Analysis can be conducted using DIFFRAC.TOPAS ver. 6 as crystal structure analysis software, and exemplary settings are as follows.
Emission Profile: CuKa5.lam
Background: Chebychev polynomial of degree 5
Instrument
   Primary radius: 280 mm
   Secondary radius: 280 mm
   Linear PSD 2Th angular range: 2.9
      FDS angle: 0.3
Full Axial Convolution
   Filament length: 12 mm
   Sample length: 15 mm
   Receiving Slit length: 12 mm
   Primary Sollers: 2.5
   Secondary Sollers: 2.5
Corrections
   Specimen displacement: Refine
   LP Factor: 0

A value of LVol-IB, or a crystallite size which is corrected with reference to an integral width calculated by the above method, is preferably employed as a crystallite size. Note that in a sample whose preferred orientation is calculated to be less than 0.8, too many particles are oriented in the same direction; thus, this sample is not suitable for determination of a crystallite size in some cases.

### <Lattice Constant>

A lattice constant of the olivine crystal structure of the positive electrode active material 100 can be determined by performing Rietveld analysis on a pattern obtained by a diffraction method. The Rietveld analysis can be performed by a method based on the above calculation of the crystallite size.

This embodiment can be combined with the contents in any of the other embodiments as appropriate.

### Embodiment 2

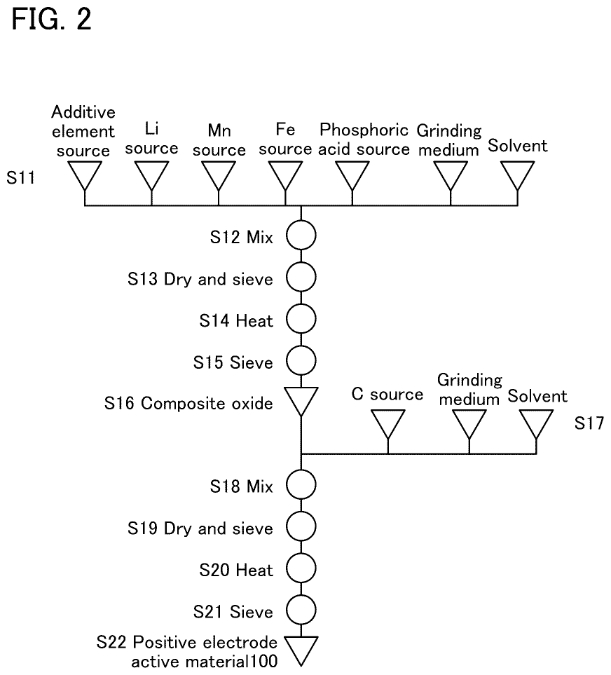

In this embodiment, an example of a method for manufacturing a positive electrode active material of one embodiment of the present invention will be described with reference to FIG. 2.

### <Step S11>

First, in Step S11 shown in FIG. 2, an additive element source, a lithium source, a manganese source, an iron source, and a phosphoric acid source are prepared. A grinding medium and a solvent for mixing are preferably prepared.

In the case where aluminum is used as the additive element, examples of an aluminum source include an aluminum compound such as aluminum oxide, aluminum hydroxide, aluminum phosphate, aluminum acetate, aluminum oxalate, aluminum nitrate, aluminum chloride, aluminum sulfate, or aluminum fluoride.

In the case where magnesium is used as the additive element, examples of a magnesium source include a magnesium compound such as magnesium oxide, magnesium hydroxide, magnesium carbonate, magnesium phosphate (Mg(H₂PO₄)₂·4H₂O, MgHPO₄·3H₂O, or Mg₃(PO₄)₂·8H₂O), magnesium acetate (Mg(CH₃COO)₂ or (CH₃COO)₂Mg·4H₂O), magnesium oxalate (MgC₂O₄·2H₂O), magnesium nitrate (Mg(NO₃)₂·6H₂O), magnesium chloride (MgCl₂·6H₂O), magnesium sulfate (MgSO₄ or MgSO₄·7H₂O), or magnesium fluoride (MgF₂).

Examples of the lithium source include a lithium compound such as lithium carbonate, lithium hydroxide, lithium oxide, lithium phosphate (Li₃PO₄), lithium acetate (CH₃CO₂Li or Li(CH₃COO)·2H₂O), lithium oxalate (Li₂C₂O₄), lithium nitrate (LiNO₃), lithium chloride (LiCl), lithium sulfate (Li₂SO₄), or lithium fluoride (LiF).

Examples of the manganese source include manganese compounds such as manganese carbonate, manganese oxide (MnO, Mn₃O₄, Mn₂O₃, MnO₂, or MnO₃), manganese hydroxide, manganese phosphate (MnPO₄), manganese acetate (Mn(OCOCH₃)₂, (CH₃COO)₃Mn·2H₂O, (CH₃COO)₂Mn·4H₂O), manganese oxalate (MnC₂O₄·2H₂O), manganese nitrate (Mn(NO₃)₂, Mn(NO₃)₂·4H₂O, or Mn(NO₃)₂·6H₂O), manganese chloride (MnCl₂·4H₂O), manganese sulfate (MnSO₄, MnSO₄·H₂O, MnSO₄·4H₂O, MnSO₄·5H₂O, or MnSO₄·7H₂O), and manganese fluoride (MnF₂ or MnF₃).

Examples of the iron source include iron compounds such as iron carbonate (FeCO₃), iron oxide (FeO, Fe₃O₄, or Fe₂O₃), iron hydroxide, iron phosphate (FePO₄·2H₂O or FePO₄·5H₂O), iron acetate (Fe(CH₃CO₂)₂), iron oxalate (Fe(C₂O₄)·2H₂O or Fe₂(C₂O₄)₃·6H₂O), iron nitrate (Fe(NO₃)₃·9H₂O or Fe(NO₃)₃·6H₂O), iron chloride (FeCl₂, FeCl₂·4H₂O, FeCl₃, or FeCl₃·6H₂O), iron sulfide (FeSO₄, FeSO₄·H₂O, FeSO₄·4H₂O, FeSO₄·5H₂O, or FeSO₄·7H₂O), and iron fluoride (FeF₂, FeF₂·4H₂O, FeF₃, or FeF₃·3H₂O).

Examples of the phosphoric acid source include phosphate compounds such as ammonium dihydrogen phosphate (NH₄H₂PO₄), diammonium hydrogen phosphate ((NH₄)₂HPO₄), and lithium dihydrogen phosphate (LiH₂PO₄).

Note that the additive element source, the lithium source, the manganese source, the iron source, and the phosphoric acid source are not necessarily different from each other, and a compound serving as two or more of them may be used. For example, the use of lithium hydroxide including magnesium, lithium carbonate including magnesium, or the like can serve as both the magnesium source and the lithium source and reduce the cost for lithium purification. Furthermore, lithium dihydrogen phosphate can serve as both the lithium source and the phosphoric acid source.

In this embodiment, aluminum oxide, lithium carbonate, manganese carbonate, iron (II) oxalate dihydrate, and ammonium dihydrogen phosphate are used as the aluminum source, the lithium source, the manganese source, the iron source, and the phosphoric acid source, respectively, and Li, Mn, Fe, Mg, and PO₄ are weighted so that the molar ratio thereof is 1:0.59:0.4:0.01:1.

In the case where a planetary rotary mill apparatus such as a ball mill is used for mixing, a grinding medium is prepared in addition to the above. As the grinding medium, a zirconia ball or the like can be used, for example. In the case of performing wet mixing, a solvent is prepared. As the solvent, dehydrated acetone can be used, for example.

### <Step S12>

Next, in Step S12, the aluminum source, the lithium source, the manganese source, the iron source, and the phosphoric acid source are mixed. The mixing can be performed by a wet method using a ball mill, for example. In this embodiment, the mixing is performed at 300 rpm for two hours while cooling is performed, and in the mixing, zirconia balls with a diameter of 3 mm are used as the grinding medium, dehydrated acetone is used as the solvent, and a planetary rotary ball mill apparatus is used.

### <Step S13>

Subsequently, in Step S13, the solvent is dried in the case where the mixing is performed by a wet method in Step S12, and the grinding medium is removed with the use of a sieve in the case where the mixing is performed using the grinding medium in Step S12, whereby a mixture is obtained. The mixture is sometimes referred to as a first mixture to be distinguished from a mixture in another step. In this embodiment, the mixture is collected after being dried in a circulation drying furnace and made to pass through a sieve with an aperture size of 300 μm.

### <Step S14>

Next, in Step S14, the first mixture is heated. The heating temperature is preferably higher than or equal to 250° C. and lower than or equal to 450° C., further preferably higher than or equal to 300° C. and lower than or equal to 400° C., the most preferably approximately 350° C. The heating time is preferably longer than or equal to 1 hour and shorter than or equal to 60 hours, further preferably longer than or equal to 2 hours and shorter than or equal to 20 hours, the most preferably approximately 10 hours. When the heating temperature is too low and/or the heating time is too short, the reaction might not be terminated, e.g., the evaporation of the hydrate and/or the carbonic acid gas is not completed. Meanwhile, when the heating temperature is too high and/or the heating time is too long, the fuel cost for heating or the like might increase and productivity might decrease.

The heating is preferably performed in an inert atmosphere or a reduction atmosphere, and can be performed in a nitrogen atmosphere or an argon atmosphere, for example. An inert atmosphere may be filled (purged) after the pressure in the reaction chamber is reduced so that the atmosphere is inhibited from entering or exiting from the reaction chamber, or a certain amount of the atmosphere may be kept flowing.

As the heating furnace, a muffle furnace, a roller hearth kiln, a rotary kiln, or the like can be used, for example. As a container holding an object to be heated, a crucible made of aluminum oxide or a setter (also referred to as a saggar) made of aluminum oxide can be used. The crucible or the setter is preferably covered with a lid before heating, in which case volatilization of a material can be prevented. Furthermore, as materials of the crucible and the setter, mullite-cordierite may be used.

In this embodiment, the first mixture is put in a crucible made of aluminum oxide with a purity of 99.9%, covered with a lid, and heated at 350° C. for 10 hours in a nitrogen flow atmosphere in a muffle furnace.

### <Step S15 and Step S16>

Next, in Step S15, the heated mixture is made to pass through a sieve. In this embodiment, a sieve with an aperture size of 300 μm is used. Through the above steps, a composite oxide is obtained (Step S16).

### <Step S17>

Next, in Step S17, a carbon source is prepared. In addition to the carbon source, a grinding medium and a solvent for mixing are preferably prepared.

As the carbon source, for example, a compound including carbon, such sugar typified by glucose or sucrace, starch, a polysaccharide typified by cellulose, or a synthetic resin typified by polyvinyl alcohol (PVA) or polyacrylic acid can be used. Carbon black such as acetylene black, graphene, graphene oxide, graphite, or the like can also be used. Alternatively, a plurality of materials selected from these can be used in combination.

For the grinding medium and the solvent, the description of Step S11 can be referred to.

### <Step S18>

Next, in Step S18, the composite oxide obtained in Step S16 and the carbon source are mixed. The mixing can be performed by a wet method using a ball mill, for example. In this embodiment, the mixing is performed at 300 rpm for two hours while cooling is performed, and in the mixing, zirconia balls with a diameter of 3 mm are used as the grinding medium, dehydrated acetone is used as the solvent, and a planetary rotary ball mill apparatus is used.

### <Step S19>

Subsequently, in Step S19, the solvent is dried in the case where the mixing is performed by a wet method in Step S18, and the grinding medium is removed with the use of a sieve in the case where the mixing is performed using the grinding medium in Step S18, whereby a mixture is obtained. The mixture is sometimes referred to as a second mixture to be distinguished from a mixture in another step. For drying and sieving, the description of Step S13 can be referred to.

### <Step S20>

Next, in Step S20, the second mixture is heated. The heating temperature is preferably higher than or equal to 500° C. and lower than or equal to 900° C., further preferably higher than or equal to 600° C. and lower than or equal to 700° C., the most preferably approximately 650° C. The heating time is preferably longer than or equal to 1 hour and shorter than or equal to 60 hours, further preferably longer than or equal to 2 hours and shorter than or equal to 20 hours, the most preferably approximately 10 hours. When the heating temperature is too low and/or the heating time is too short, the olivine crystal structure might not be formed or the carbon source might not be sufficiently carbonized. Meanwhile, when the heating temperature is too high and/or the heating time is too long, sintering progresses and a secondary particle might become too large, or productivity might decrease, for example.

For the atmosphere at the time of the heating, the heating furnace, and the container, the description of Step S14 can be referred to.

In this embodiment, the second mixture is put in a crucible made of aluminum oxide with a purity of 99.9%, covered with a lid, and heated at 650° C. for 10 hours in a nitrogen flow atmosphere in a muffle furnace.

### <Step S21 and Step S22>

Next, in Step S21, the heated material is made to pass through a sieve. In this embodiment, a sieve with an aperture size of 53 μm is used. Through the above steps, the positive electrode active material 100 is obtained (Step S22).

Through the above steps, the positive electrode active material 100 can be manufactured.

Although FIG. 2 shows an example in which a positive electrode active material is formed by a solid phase method, one embodiment of the present invention is not limited thereto. The positive electrode active material can be formed by not only the solid phase method but also a hydrothermal method, a coprecipitation method, a sol-gel method, a spray dry method, or the like. The positive electrode active material can be formed by a combination of a plurality of methods selected from these methods.

This embodiment can be combined with the contents in any of the other embodiments as appropriate.

### Embodiment 3

In this embodiment, structures of lithium-ion secondary batteries are described.

### [Positive Electrode]

A positive electrode includes a positive electrode active material layer and a positive electrode current collector. The positive electrode active material layer includes a positive electrode active material and may further include at least one of a conductive additive and a binder.

The positive electrode active material described in the above embodiment can be used.

### <Positive Electrode Active Material>

For the positive electrode active material, the positive electrode active material 100 described in any of the above embodiments and a different positive electrode active material may be mixed and used.

Examples of the different positive electrode active material mentioned above include a composite oxide with an olivine crystal structure, a composite oxide with a layered rock-salt crystal structure, and a composite oxide with a spinel crystal structure. For example, a compound such as LiFePO₄, LiFeO₂, LiCoO₂, LiNiO₂, LiMnO₂, LiNiₐMn_{b}C_{c}O₂ (a+b+c=1), LiMn₂O₄, V₂O₅, Cr₂O₅, or MnO₂ can be given.

As the different positive electrode active material, it is preferable to mix lithium nickel oxide (LiNiO₂ or LiNi₁₋ₓMxO₂ (0<x<1)(M=Co, Al, or the like)) with a lithium-containing material that has a spinel crystal structure and includes manganese, such as LiMn₂O₄. This composition can improve the characteristics of the secondary battery.

### <Conductive Additive>

A conductive additive is also referred to as a conductivity-imparting agent or a conductive material, and a carbon material can be used as the conductive additive. A conductive additive is attached between a plurality of active materials, whereby the plurality of active materials are electrically connected to each other, and the conductivity increases. Note that in this specification and the like, the term “attach” refers not only to a state where an active material and a conductive additive are physically in close contact with each other, but also the following cases: a case where covalent bonding occurs, a case where bonding with the Van der Waals force occurs, a case where a conductive additive covers part of the surface of an active material, a case where a conductive additive is embedded in surface roughness of an active material, a case where an active material and a conductive additive are electrically connected to each other without being in contact with each other, and other cases.

Specific examples of carbon materials that can be used as the conductive additive include carbon black (e.g., furnace black, acetylene black, or graphite). Graphene, multilayer graphene, graphene oxide, and/or reduced graphene oxide can also be used.

In addition, graphene and acetylene black are preferably mixed to be used, in which case fast charging can be achieved. Using such a positive electrode for lithium-ion secondary batteries for vehicles is particularly effective.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer can be used, for example. Alternatively, fluororubber can be used as the binder.

As the binder, for example, water-soluble polymers are preferably used. As the water-soluble polymer, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

In addition, graphene, multilayer graphene, graphene oxide, and/or reduced graphene oxide can serve not only as a conductive additive but also as a binder.

Two or more of the above materials may be used in combination for the binder.

### <Positive Electrode Current Collector>

For the current collector, a material that has high conductivity, such as a metal like stainless steel, iron, gold, platinum, aluminum, or titanium, or an alloy thereof, can be used. It is preferable that a material used for the positive electrode current collector not be dissolved at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### [Negative Electrode]

The negative electrode includes a negative electrode active material layer and a negative electrode current collector. The negative electrode active material layer includes a negative electrode active material and may further include a conductive additive and a binder.

### <Negative Electrode Active Material>

As the negative electrode active material, for example, an alloy-based material and/or a carbon material can be used.

As the carbon material used as the negative electrode active material, one or more selected from graphite, graphitizing carbon (soft carbon), non-graphitizing carbon (hard carbon), carbon fiber (carbon nanotube), graphene, a graphene compound, carbon black, and the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into the graphite (while a lithium-graphite intercalation compound is generated). For this reason, a lithium-ion secondary battery using graphite can have a high operating voltage. In addition, graphite is preferable because of its advantages such as a relatively high capacity per unit volume, relatively small volume expansion, low cost, and a higher level of safety than that of lithium metal.

As the negative electrode active material, an element that enables charge and discharge reactions by alloying and dealloying reactions with lithium can be used. For example, one or more materials selected from silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. Alternatively, a compound including any of the above elements may be used. Examples of the compound include titanium silicide, titanium silicon oxide, SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound including the element, for example, are referred to as alloy-based materials in some cases. An alloy-based material such as silicon is preferable as a negative electrode active material of a low-temperature secondary battery because a decrease in charge and discharge capacity at low temperatures is sometimes inhibited as compared with graphite.

In this specification and the like, “SiO” refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, further preferably greater than or equal to 0.3 and less than or equal to 1.2.

A material used in formation of the graphene compound may be mixed with the graphene compound to be used for an active material layer. For example, particles used as a catalyst in formation of the graphene compound may be mixed with the graphene compound. As an example of the catalyst in formation of the graphene compound, particles including any of silicon oxide (SiO₂ or SiOₓ(x<2)), aluminum oxide, iron, nickel, ruthenium, iridium, platinum, copper, germanium, and the like can be given. The D50 of the particles is preferably less than or equal to 1 μm, further preferably less than or equal to 100 nm.

A silicon particle covered with a graphene compound may be used as the negative electrode active material. In that case, it is further preferable that a space capable of buffering structural changes be provided between the graphene compound and the silicon particle.

As the negative electrode active material, one or more oxides selected from titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), and molybdenum dioxide (MoO₂) can be used.

Still alternatively, as the negative electrode active material, Li₃₋ₓMₓN (M=Co, Ni, or Cu) with a Li₃N structure, which is a nitride including lithium and a transition metal, can be used. For example, Li_{2.6}Co_{0.4}N is preferable because of its high discharge capacity (900 mAh/g and 1890 mAh/cm³).

A nitride including lithium and a transition metal is preferably used as the negative electrode active material, in which case lithium ions are included in the negative electrode active material and thus the negative electrode active material can be used in combination with a material for the positive electrode active material which does not include lithium ions, such as V₂O₅ or Cr₃O₈. Note that in the case of using a material including lithium ions as the positive electrode active material, the nitride including lithium and a transition metal can be used as the negative electrode active material by extracting the lithium ions included in the positive electrode active material in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

A combination of two or more of the above negative electrode active materials may be used; for example, a negative electrode active material in which graphite and silicon particles are mixed may be used. The silicon particles refer to silicon powders that are the negative electrode active material of the lithium-ion secondary battery, and the average diameter of the particle size distribution, i.e., the average particle diameter is around 100 nm; the silicon particles are referred to as nanosilicon particles in some cases. In order to obtain silicon particles to be used, it is preferable that a silicon source be ground and particle diameters be adjusted to be uniform. The silicon particles can include at least one of silicon, silicon oxide, and silicon alloy. Although laser diffraction particle size distribution measurement can be typically used for measurement of a particle size, the measurement is not limited thereto. A major diameter of a particle cross section may be measured by analysis using a scanning electron microscope (SEM), a transmission electron microscope (TEM), or the like.

For the conductive additive and the binder that can be included in the negative electrode active material layer, materials similar to those for the conductive additive and the binder that can be included in the positive electrode active material layer can be used.

### <Negative Electrode Current Collector>

For the negative electrode current collector, copper or the like can be used in addition to a material similar to that of the positive electrode current collector. Note that a material that does not alloy with carrier ions of lithium or the like is preferably used for the negative electrode current collector.

### [Electrolyte Solution]

The electrolyte solution includes an organic solvent; the organic solvent of the electrolyte of one embodiment of the present invention is not limited to a liquid at 25° C. and may be a solid at 25° C. or a semi-solid at normal temperature. Note that the organic solvent of the electrolyte of one embodiment of the present invention is preferably a liquid in a wide temperature range from temperatures below freezing to high temperatures; however, the present invention is not limited thereto. The organic solvent may be a liquid, a solid, or a semi-solid in a wide temperature range from temperatures below freezing to high temperatures.

As an organic solvent, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), 1,3-propanesultone (PS), fluoroethylene carbonate (FEC), methyl 3,3,3-trifluoropropionate (MTFP), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio.

PS has a HOMO level and a LUMO level equivalent to those of EC and DEC; thus, PS is less likely to be oxidized and reduced even at a high cut-off voltage, and is likely to be a high molecule when decomposed on the surface of the positive electrode active material. Accordingly, PS is advantageous in that it is unlikely to be gasified by becoming a decomposition product with a small molecular weight. Thus, the electrolyte solution preferably includes PS at higher than or equal to 0.1 wt % and lower than or equal to 10 wt %, further preferably higher than or equal to 0.25 wt % and lower than or equal to 7.5 wt %.

FEC, which is one of cyclic carbonates, has a high dielectric constant and thus has an effect of promoting dissociation of a lithium salt when used in an organic solvent. Meanwhile, because FEC includes a substituent with an electron-withdrawing property, a lithium ion is desolvated with FEC more easily than with EC. Specifically, the solvation energy of a lithium ion is lower in FEC than in EC not including a substituent with an electron-withdrawing property. Thus, lithium ions are likely to be extracted from surfaces of a positive electrode active material and a negative electrode active material, which can reduce an internal resistance of a secondary battery. In addition, FEC has a deep highest occupied molecular orbital (HOMO) level and is thus not easily oxidized, meaning high oxidation resistance. On the other hand, FEC disadvantageously has high viscosity. In view of this, a mixed organic solvent including not only FEC but also MTFP is preferably used for the electrolyte solution. MTFP, which is one of linear carbonates, can have an effect of reducing the viscosity of an electrolyte solution or maintaining the viscosity at room temperature (typically, 25° C.) even at low temperatures (typically, 0° C.). Furthermore, while the solvation energy is lower in MTFP than in methyl propionate (abbreviation: MP) not including a substituent with an electron-withdrawing property, MTFP may solvate a lithium ion when used for the electrolyte solution. In the case of using a mixed organic solvent including both FEC and MTFP, y in the volume ratio FEC: MTFP=1: y preferably greater than or equal to 2 and less than or equal to 20, further preferably greater than or equal to 4 and less than or equal to 9.

It is preferable that the above-described organic solvent be highly purified and include a small amount of dust particles or molecules other than constituent molecules of the organic solvent (hereinafter also simply referred to as impurities and include oxygen (O₂), water (H₂O), and moisture). It is preferable that generation of a reaction by-product in synthesis be inhibited through appropriate purification. Specifically, the impurity in the electrolyte is less than or equal to 100 ppm, preferably less than or equal to 50 ppm, further preferably less than 10 ppm. The concentration of moisture among the impurity can be detected by Karl Fischer titration.

Furthermore, it is preferable that peaks attributed to impurities in the above-described organic solvent be hardly observed by NMR measurement or the like. The expression “hardly observed” includes the case where the ratio of the integral area of the peak attributed to impurities to the integral area of the peak attributed to the main component (such a ratio is simply referred to as an integral ratio) is less than or equal to 0.005, preferably less than or equal to 0.002. An apparatus used for the NMR measurement is not particularly limited, and for example, “AVANCE III 400” (Bruker Corporation) can be used. Among the five peaks of acetonitrile derived from acetonitrile-d₃ used in a solvent in the 1H-NMR measurement, the center peak can be 1.94 ppm.

For example, in the case of MTFP, it is known that when 1H-NMR is measured using an acetonitrile-d₃ solvent, four peaks appear at 8 of greater than or equal to 3.29 ppm and less than or equal to 3.43 ppm. However, in the case where another peak appears in the vicinity of the above range, for example, another peak appears at 8 of greater than or equal to 3.24 ppm and less than or equal to 3.29 ppm, the peak is probably derived from impurities. Accordingly, when the ratio (integral ratio) of a peak area greater than or equal to 3.24 ppm and less than or equal to 3.29 ppm to a peak area greater than or equal to 3.29 ppm and less than or equal to 3.43 ppm is less than or equal to 0.005, preferably less than or equal to 0.002, peaks attributed to impurities are hardly observed.

Alternatively, the use of one or more kinds of ionic liquids (room temperature molten salts) that are unlikely to burn and volatize as the solvent of the electrolyte solution can prevent a power storage device from exploding and catching fire even when the power storage device internally shorts out or the internal temperature increases owing to overcharge or the like. An ionic liquid includes a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (Li(C₂O₄)₂, LiBOB) can be used, or two or more of these lithium salts can be used in an appropriate combination in an appropriate ratio.

The electrolyte solution can include an additive agent. The additive agent can inhibit a decomposition reaction of an electrolyte solution which might occur on a positive electrode surface or a negative electrode surface when a secondary battery operates at a high voltage and/or high temperatures. As the additive agent, for example, propane sultone (PS), vinylene carbonate (VC), tert-butylbenzene (TBB), lithium bis(oxalate) borate (LiBOB), 1,3,6-hexanetricarbonitrile, ethyl 2-methylbutanoate, ethyl 2-methylpentanoate, or propyl 2-methylbutyrate is preferably used. PS is particularly preferable as the additive because it improves the cycle performance.

As the additive agent, one or more, or two or more kinds of dinitrile compounds can be used. Specific examples of the dinitrile compound include succinonitrile, glutaronitrile, adiponitrile (ADN), and ethylene glycol bis(propionitrile) ether (EGBE).

Furthermore, fluorobenzene may be added to the above organic solvent. The concentration of the additive agent in the whole electrolyte solution is, for example, higher than or equal to 0.1 wt % and lower than or equal to 5 wt %. PS or EGBE is preferable because it forms a favorable coating film on a positive electrode at the time of charge and discharge, which improves the cycle performance. Fluorobenzene (FB) is preferable because it improves the wettability of the organic solvent with respect to the positive electrode and the negative electrode. The dinitrile compound is preferable because its nitrile groups are oriented to the positive electrode and the negative electrode and oxidative decomposition of the organic solvent is hindered, whereby resistance against a high voltage can be increased. Furthermore, the dinitrile compound is preferable because it can inhibit dissolution of copper used in the current collector of the negative electrode at the time of overdischarge. Considering the usage of the secondary battery at a high voltage, a dinitrile compound is preferably added.

The electrolyte solution used for the power storage device is preferably a highly-purified electrolyte solution with only a small amount of dust particles and elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%.

Alternatively, a polymer gel electrolyte obtained in such a manner that a polymer is swelled with an electrolyte solution may be used instead of the electrolyte solution.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. For example, a polymer having a polyalkylene oxide structure, such as polyethylene oxide (PEO), PVDF, polyacrylonitrile, or a copolymer including any of them can be used. For example, PVDF-HFP, which is a copolymer of PVDF and hexafluoropropylene (HFP), can be used. The formed polymer may be porous.

Instead of the electrolyte solution, it is possible to use a solid electrolyte including an inorganic material such as a sulfide-based or oxide-based inorganic material, or a solid electrolyte including a high-molecular material such as a polyethylene oxide (PEO)-based high-molecular material. When the solid electrolyte is used, a separator or a spacer is not necessary. Furthermore, the battery can be entirely solidified; accordingly, there is no risk of liquid leakage and thus the safety of the battery is dramatically improved.

### [Separator]

In the case of using the electrolyte solution and the electrolyte of the polymer gel, a separator is placed between the positive electrode and the negative electrode. As a separator, for example, a fiber including cellulose such as paper; nonwoven fabric; a glass fiber; ceramics; a synthetic fiber using nylon (polyamide), vinylon (polyvinyl alcohol-based fiber), polypropylene (referred to as PP), polyimide (referred to as PI), polyester, acrylic, polyolefin, or polyurethane; or the like can be used. The separator can have a porosity in thickness higher than or equal to 35% and lower than or equal to 90%, preferably higher than or equal to 60% and lower than or equal to 85%. A separator using polypropylene can have a porosity higher than or equal to 35% and lower than or equal to 45%. A separator using polyimide can have a porosity higher than or equal to 75% and lower than or equal to 85%. The thickness of the separator is preferably greater than or equal to 10 μm and less than or equal to 80 μm, further preferably greater than or equal to 20 μm and less than or equal to 60 μm. A separator using polyimide is preferable; it can have a high porosity and thus can have a large thickness (typically, a thickness greater than or equal to 50 μm and less than or equal to 60 μm) without an increase in lithium ion transport resistance, thereby improving the safety of a lithium-ion secondary battery.

The separator is preferably processed into a bag-like shape to wrap one of the positive electrode and the negative electrode.

The separator may have a multilayer structure. For example, an organic material film of polypropylene, polyethylene, or the like can be coated with a ceramics-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

The use of a separator having a multilayer structure makes it possible to maintain the safety of the lithium-ion secondary battery even when the total thickness of the separator is small, so that the capacity per volume of the lithium-ion secondary battery can be increased.

### [Exterior Body]

For an exterior body included in the lithium-ion secondary battery, a metal material such as aluminum or a resin material can be used, for example. A film-like exterior body can also be used. As a film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

This embodiment can be implemented in appropriate combination with any of the other embodiments.

### Embodiment 4

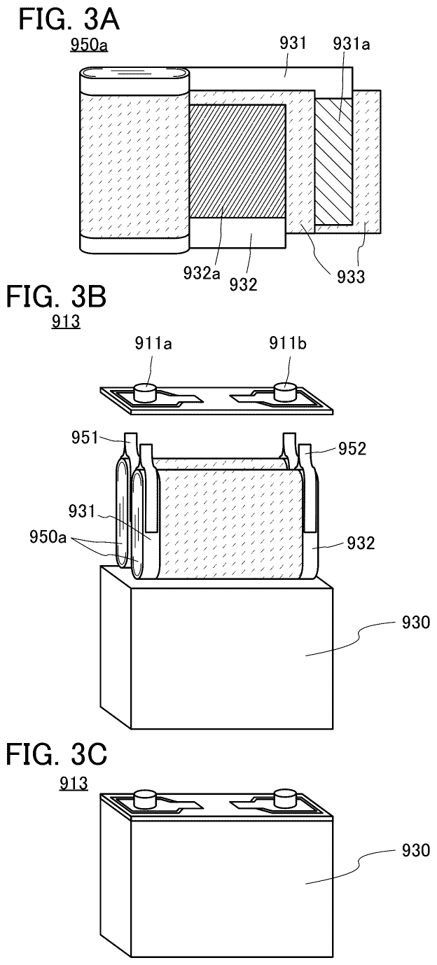

In this embodiment, a mode example of a lithium-ion secondary battery is described with reference to FIGS. 3A to 3C.

FIG. 3A shows a wound body 950a included in a lithium-ion secondary battery 913, FIG. 3B shows an exploded perspective view of the lithium-ion secondary battery 913, and FIG. 3C shows an external view of the lithium-ion secondary battery 913. The lithium-ion secondary battery 913 includes a positive electrode 932 including the positive electrode active material described in the above embodiments, a negative electrode 931, an electrolyte layer, and a separator 933, and the negative electrode 931 includes a negative electrode active material layer 931a. The positive electrode 932 includes a positive electrode active material layer 932a. They are wound as shown in FIG. 3A.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As shown in FIG. 3B, the negative electrode 931 is electrically connected to a terminal 951. The terminal 951 is electrically connected to a terminal 911a. The positive electrode 932 is electrically connected to a terminal 952. The terminal 952 is electrically connected to a terminal 911b.

As shown in FIG. 3C, the wound body 950a is covered with a housing 930, whereby the lithium-ion battery 913 is completed. The housing 930 is preferably provided with a safety valve, an overcurrent protection element, and the like. A safety valve is a valve to be released by a predetermined internal pressure of the housing 930 in order to prevent the battery from exploding.

As shown in FIG. 3B, the lithium-ion battery 913 may include a plurality of wound bodies 950a. The use of the plurality of wound bodies 950a enables the lithium-ion battery 913 to have higher charge/discharge capacities.

When the positive electrode active material of the present invention is used for the lithium-ion secondary battery 913 including a wound body, the secondary battery can have a high energy density and favorable electrical characteristics in a wide temperature range.

The contents in this embodiment can be combined with any of the contents in the other embodiments as appropriate.

### Embodiment 5

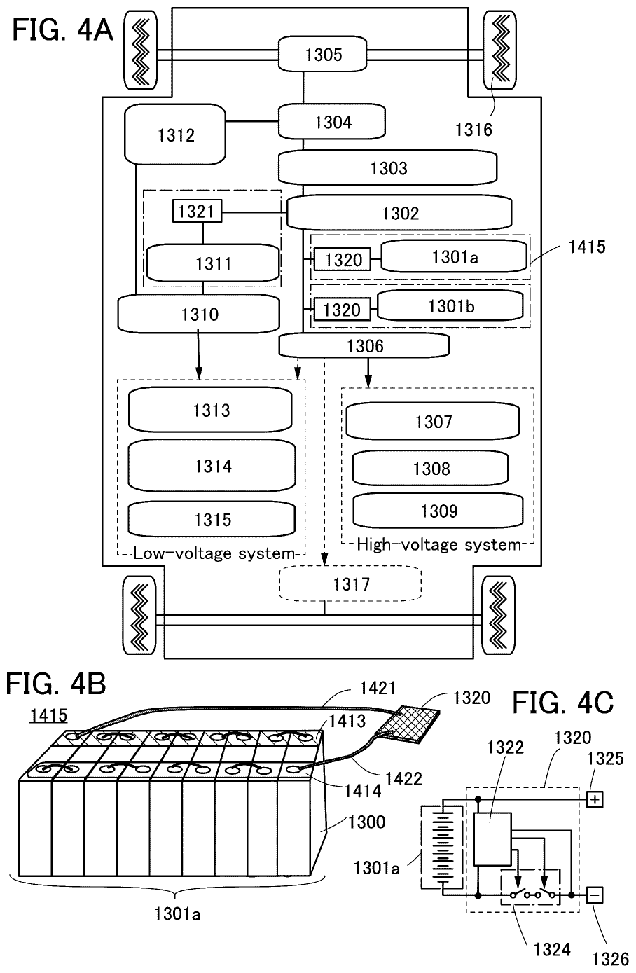

In this embodiment, an example of application to an electric vehicle (EV) will be described with reference to FIGS. 4A to 4C.

As shown in FIG. 4A, the electric vehicle is provided with first batteries 1301a and 1301b as main lithium-ion secondary batteries for driving and a second battery 1311 that supplies electric power to an inverter 1312 for starting a motor 1304. When the positive electrode active material of the present invention is used for the first batteries 1301a and 1301b, the secondary battery can have a high energy density and favorable electrical characteristics in a wide temperature range.

The second battery 1311 is also referred to as a cranking battery (also referred to as a starter battery). The second battery 1311 only needs high output and does not necessarily have high capacity, and the capacity of the second battery 1311 is lower than that of the first batteries 1301a and 1301b.

The internal structure of the first battery 1301a may be a wound structure or a stacked-layer structure. A lithium-ion secondary battery including the positive electrode active material of one embodiment of the present invention may be used as the first battery 1301a. The use of the lithium-ion secondary battery including the positive electrode active material of one embodiment of the present invention as the first battery 1301a can achieve an electric vehicle that has a high mileage and can be used at a wide environment temperature.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of lithium-ion secondary batteries, large electric power can be extracted. The plurality of lithium-ion secondary batteries may be connected in parallel, connected in series, or connected in series after being connected in parallel. The plurality of lithium-ion secondary batteries are also referred to as an assembled battery.

In order to cut off electric power from the plurality of lithium-ion secondary batteries, the lithium-ion secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

The first battery 1301a is described with reference to FIG. 4B.

FIG. 4B shows an example in which nine rectangular lithium-ion secondary batteries 1300 form one battery pack 1415. The nine rectangular lithium-ion secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the lithium-ion secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of lithium-ion secondary batteries are preferably fixed by the fixing portions 1413 and 1414 and a battery container box, for example. Furthermore, the one electrode is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a battery operating system or a battery oxide semiconductor (BTOS) in some cases.

A metal oxide functioning as an oxide semiconductor is preferably used. For example, as the oxide, a metal oxide such as an In-M-Zn oxide (the element Mis one or more of aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is used. In particular, the In-M-Zn oxide that can be used as the oxide is preferably a c-axis aligned crystal oxide semiconductor (CAAC-OS) or a cloud-aligned composite oxide semiconductor (CAC-OS). Alternatively, an In oxide, an In—Ga oxide, or an In—Zn oxide may be used as the oxide.

The control circuit portion 1320 preferably uses a transistor using an oxide semiconductor because the transistor using an oxide semiconductor can be used in a low-temperature environment. For the process simplicity, the control circuit portion 1320 may be formed using transistors of the same conductivity type. A transistor using an oxide semiconductor in its semiconductor layer has an operating ambient temperature range from −40° C. to 150° C., both inclusive, which is wider than that of a single crystal Si transistor, and thus shows a smaller change in characteristics than the single crystal Si transistor when the lithium-ion secondary battery is heated. The off-state current of the transistor using an oxide semiconductor is lower than the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety.

The control circuit portion 1320 that includes a memory circuit including a transistor using an oxide semiconductor can also function as an automatic control device for the lithium-ion secondary battery to resolve ten items of causes of instability, such as a micro-short circuit. Examples of functions of resolving the ten items of causes of instability include prevention of overcharge, prevention of overcurrent, control of overheating during charge, cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the lithium-ion secondary battery can be extremely small in size.

A micro-short circuit refers to a minute short circuit caused in a lithium-ion secondary battery. One of the supposed causes of a micro-short circuit is as follows. Uneven distribution of a positive electrode active material due to charge and discharge performed multiple times causes local current concentration at part of the positive electrode and part of the negative electrode. Another supposed cause is generation of a by-product due to a side reaction.

It can be said that the control circuit portion 1320 not only detects a micro-short circuit but also senses a terminal voltage of the lithium-ion secondary battery and controls the charge and discharge state of the lithium-ion secondary battery. For example, to prevent overcharge, an output transistor of a charge circuit and an interruption switch can be turned off substantially at the same time.

FIG. 4C shows an example of a block diagram of the battery pack 1415 shown in FIG. 4B.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the lithium-ion secondary battery to be used, and imposes the upper limit of current from the outside, the upper limit of output current to the outside, and the like. The range from the lower limit voltage to the upper limit voltage of the lithium-ion secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed with a combination of an n-channel transistor and a p-channel transistor. The switch portion 1324 is not limited to a switch including a Si transistor using single crystal silicon; the switch portion 1324 may be formed using, for example, a power transistor including germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOx, where x is a real number greater than 0), or the like. A memory element using an OS transistor can be freely placed by being stacked over a circuit using a Si transistor, for example; hence, integration can be easy. The control circuit portion 1320 using an OS transistor can be stacked and integrated over the switch portion 1324 so as to form one chip, which enables reduction in size.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. There is an advantage that the second battery 1311 can be maintenance-free when a lithium-ion secondary battery is used; however, in the case of long-term use, for example three years or more, anomaly that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

Although this embodiment describes an example in which lithium-ion secondary batteries are used as both the first battery 1301a and the second battery 1311, a lead storage battery, an all-solid-state battery, or an electric double layer capacitor may be used as the second battery 1311. When the positive electrode active material of the present invention is used for the above-described lithium-ion secondary battery, the secondary battery can have a high energy density and favorable electrical characteristics in a wide temperature range.

Regenerative energy generated by rolling of tires 1316 is transmitted to the motor 1304 through a gear 1305, and is stored in the second battery 1311 through a motor controller 1303, a battery controller 1302, and a control circuit portion 1321. Alternatively, the regenerative energy is stored in the first battery 1301a through the battery controller 1302 and the control circuit portion 1320. Alternatively, the regenerative energy is stored in the first battery 1301b through the battery controller 1302 and the control circuit portion 1320. For efficient charge with regenerative energy, the first batteries 1301a and 1301b are desirably capable of fast charge.

The battery controller 1302 can set the charge voltage, charge current, and the like of the first batteries 1301a and 1301b. The battery controller 1302 can set charge conditions in accordance with charge performance of a lithium-ion secondary battery used, so that fast charge can be performed.

Although not shown, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a connection cable or the connection cable of the charger is sometimes provided with a control circuit. The control circuit portion 1320 is also referred to as an electronic control unit (ECU). The ECU is connected to a controller area network (CAN) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, or a three-phase 200V outlet (50 kW), for example. Furthermore, charge can be performed with electric power supplied from external charge equipment by a contactless power feeding method or the like.

Next, examples in which the lithium-ion secondary battery of one embodiment of the present invention is mounted on a vehicle, typically a transport vehicle, will be described.

Mounting the lithium-ion secondary battery on vehicles can achieve next-generation clean energy vehicles such as hybrid vehicles (HVs), electric vehicles (EVs), and plug-in hybrid vehicles (PHVs). The lithium-ion secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft.

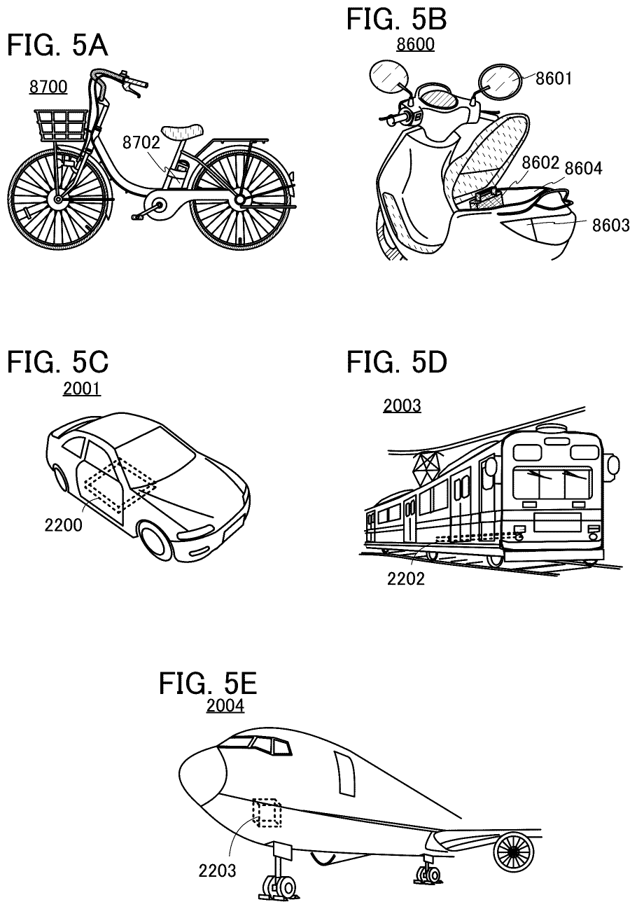

FIGS. 5A to 5E show examples of vehicles and the like each including the lithium-ion secondary battery of one embodiment of the present invention.

FIG. 5A shows an example of an electric bicycle using the lithium-ion secondary battery of one embodiment of the present invention. The lithium-ion secondary battery of one embodiment of the present invention can be used for an electric bicycle 8700 shown in FIG. 5A. The lithium-ion secondary battery of one embodiment of the present invention may include a protection circuit.

The electric bicycle 8700 includes a power storage device 8702. The power storage device 8702 can supply electricity to a motor that assists a rider. The power storage device 8702 can be taken off from the main body of the electric bicycle 8700 and carried. A plurality of lithium-ion secondary batteries of one embodiment of the present invention are incorporated in the power storage device 8702, and the remaining battery capacity and the like can be displayed on a display portion. When the positive electrode active material of the present invention is used for the lithium-ion secondary battery, the secondary battery can have a high energy density and favorable electrical characteristics in a wide temperature range.

FIG. 5B shows an example of a motorcycle including the lithium-ion secondary battery of one embodiment of the present invention. A motor scooter 8600 shown in FIG. 5B includes a power storage device 8602, side mirrors 8601, and indicators 8603. Furthermore, in the motor scooter 8600, the power storage device 8602 can be held in a storage unit under seat 8604. The power storage device 8602 can supply electricity to the indicators 8603. In the case where the motor scooter includes a motor, the power storage device 8602 can supply electricity also to the motor. When the positive electrode active material of the present invention is used for the lithium-ion secondary battery included in the power storage device 8602, the secondary battery can have a high energy density and favorable electrical characteristics in a wide temperature range.

An automobile 2001 shown in FIG. 5C is an electric vehicle that runs on the power of an electric motor. Alternatively, the automobile 2001 is a hybrid vehicle capable of driving using either an electric motor or an engine as appropriate. In the case where the lithium-ion secondary battery is mounted on the vehicle, an example of the lithium-ion secondary battery described in the above embodiment is provided at one position or several positions. When the positive electrode active material of the present invention is used for the lithium-ion secondary battery mounted on a vehicle, the secondary battery can have a high energy density and favorable electrical characteristics in a wide temperature range.

The automobile 2001 shown in FIG. 5C includes a battery pack 2200, and the battery pack includes a battery module in which a plurality of lithium-ion secondary batteries are connected to each other. The battery pack 2200 preferably further includes a charge control device that is electrically connected to the battery module.

The automobile 2001 can be charged when the lithium-ion secondary battery included in the automobile 2001 is supplied with electric power from external charge equipment by a plug-in system, a contactless charge system, or the like. In charge, a given method such as CHAdeMO (registered trademark) or Combined Charging System can be employed as a charge method, the standard of a connector, or the like as appropriate. As the external charge equipment, a charge station provided in a commerce facility, a power source in a house, and the like can be given. For example, with use of the plug-in technique, the power storage device mounted on the automobile 2001 can be charged by being supplied with electric power from the outside. Charge can be performed by converting AC power into DC power through a converter such as an ACDC converter.

Although not shown, the vehicle may be provided with a power receiving device so that it can be charged by being supplied with electric power from an above-ground power transmitting device in a contactless manner. In the case of the contactless power feeding system, by fitting a power transmitting device in a road or an exterior wall, charge can be performed not only when the electric vehicle is stopped but also when driven. In addition, the contactless power feeding system may be utilized to perform transmission and reception of electric power between two vehicles. Furthermore, a solar cell may be provided in the exterior of the vehicle to charge the lithium-ion secondary battery while the vehicle is stopped or while the vehicle is moving. To supply electric power in such a contactless manner, an electromagnetic induction method or a magnetic resonance method can be used.

FIG. 5D shows a large transport vehicle 2003 having a motor controlled by electricity as an example. A battery module of the transport vehicle 2003 has 100 or more lithium-ion secondary batteries with a nominal voltage of 3.0 V or higher and 5.0 V or lower connected in series to have a maximum voltage of 600 V. A battery pack 2202 has the same function as that in FIG. 5C except, for example, the number of lithium-ion secondary batteries configuring the battery module; thus, the description is omitted. When the positive electrode active material of the present invention is used for the lithium-ion secondary battery included in the module, the secondary battery can have a high energy density and favorable electrical characteristics in a wide temperature range.

FIG. 5E shows an aircraft 2004 having a combustion engine as an example. The aircraft 2004 can also be regarded as a kind of transport vehicle because it has wheels for takeoff and landing, and includes a battery pack 2203 that includes a charge control device and a battery module configured by connecting a plurality of lithium-ion secondary batteries.

The battery module of the aircraft 2004 includes, for example, eight 4-V lithium-ion secondary batteries that are connected in series to have a maximum voltage of 32 V. The battery pack 2203 has the same function as that in FIG. 5C except, for example, the number of lithium-ion secondary batteries configuring the battery module; thus, the description is omitted.

The contents in this embodiment can be combined with any of the contents in the other embodiments as appropriate.

### Embodiment 6

In this embodiment, examples of electronic devices each including the lithium-ion secondary battery of one embodiment of the present invention will be described. Examples of electronic devices including the lithium-ion secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

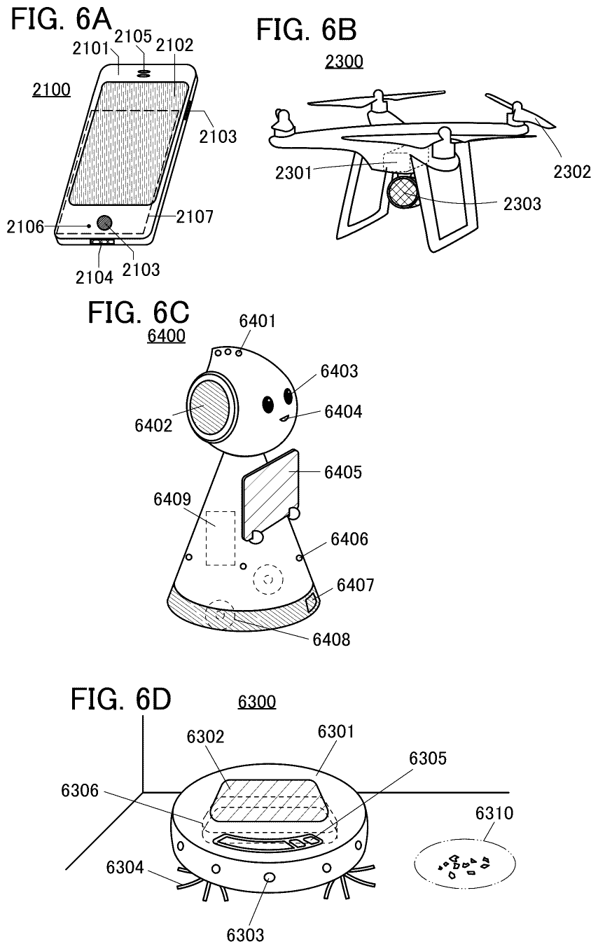

FIG. 6A shows an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a lithium-ion secondary battery 2107. When the positive electrode active material of the present invention is used for the lithium-ion secondary battery, the secondary battery can have a high energy density and favorable electrical characteristics in a wide temperature range.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor; a touch sensor; a pressure sensitive sensor; or an acceleration sensor is preferably mounted, for example.

FIG. 6B shows an unmanned aircraft 2300 including a plurality of rotors 2302. The unmanned aircraft 2300 is sometimes also referred to as a drone. The unmanned aircraft 2300 includes a lithium-ion secondary battery 2301 of one embodiment of the present invention, a camera 2303, and an antenna (not shown). The unmanned aircraft 2300 can be remotely controlled through the antenna. When the positive electrode active material of the present invention is used for the lithium-ion secondary battery, the secondary battery can have a high energy density and favorable electrical characteristics in a wide temperature range.

FIG. 6C shows an example of a robot. A robot 6400 shown in FIG. 6C includes a lithium-ion secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the lithium-ion secondary battery 6409 of one embodiment of the present invention and a semiconductor device or an electronic component. When the positive electrode active material of the present invention is used for the lithium-ion secondary battery, the secondary battery can have a high energy density and favorable electrical characteristics in a wide temperature range.

FIG. 6D shows an example of a cleaning robot. A cleaning robot 6300 includes a display portion 6302 placed on a top surface of a housing 6301, a plurality of cameras 6303 placed on a side surface of the housing 6301, a brush 6304, operation buttons 6305, a lithium-ion secondary battery 6306, a variety of sensors, and the like. Although not shown, the cleaning robot 6300 is provided with a tire, an inlet, and the like. The cleaning robot 6300 is self-propelled, detects dust 6310, and sucks up the dust through the inlet provided on a bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the lithium-ion secondary battery 6306 of one embodiment of the present invention and a semiconductor device or an electronic component. When the positive electrode active material of the present invention is used for the lithium-ion secondary battery, the secondary battery can have a high energy density and favorable electrical characteristics in a wide temperature range.

This embodiment can be implemented in appropriate combination with any of the other embodiments.

### Example

In this example, a positive electrode active material in which aluminum as an additive element formed a solid solution with LiMnₓFe₁₋ₓPO₄ (0<x<1) was formed, and the characteristics thereof were evaluated.

### <Formation of Positive Electrode Active Material>

The formation of the positive electrode active material in this example will be described with reference to the manufacturing method shown in FIG. 2.

First, Al₂O₃, Li₂CO₃, MnCO₃, FeC₂O₄·2H₂O, and NH₄H₂PO₄ were prepared as an Al source, a Li source, a Mn source, a Fe source, and a phosphoric acid source, respectively, and weighed to be LiMn_{0.59}Fe_{0.4}Al_{0.01}PO₄ in composition. A zirconia ball with a diameter of 3 mm was used as a grinding medium, and dehydrated acetone was used as a solvent.

These materials were mixed at 300 rpm for 2 hours in a planetary rotary ball mill apparatus while being cooled. The first mixture was collected after being dried in a circulation drying furnace and made to pass through a sieve with an aperture size of 300 μm.

The first mixture was put in a crucible made of aluminum oxide with a purity of 99.9%, covered with a lid, and heated at 350° C. for 10 hours in a nitrogen flow atmosphere in a muffle furnace. The heated mixture was made to pass through a sieve with an aperture size of 300 μm, whereby a composite oxide was obtained.

As a C source, glucose was used, and the composite oxide and the C source were weighed so that the weight ratio thereof was 10:1. A zirconia ball with a diameter of 3 mm was prepared as a grinding medium, and dehydrated acetone was prepared as a solvent.

These materials were mixed at 300 rpm for two hours in a planetary rotary ball mill apparatus. The second mixture was collected after being dried in a circulation drying furnace and made to pass through a sieve with an aperture size of 300 μm.

The second mixture was put in a crucible made of aluminum oxide with a purity of 99.9%, covered with a lid, and heated at 650° C. for 10 hours in a nitrogen flow atmosphere in a muffle furnace. The heated mixture was made to pass through a sieve with an aperture size of 53 μm, whereby a positive electrode material was obtained.

The positive electrode active material which is formed in the above steps and coated with carbon is referred to as C/LiMn_{0.59}Fe_{0.4}Al_{0.01}PO₄ or Al 1%.

In the same steps as those described above except for the amount of the aluminum source and the manganese source, the following positive electrode active materials were formed: a comparative example not including Al, Al 1%, and Al 10%. The compositions thereof are shown in Table 1.

TABLE 1

| | Composition |
|---|---|
| Comparative example | C/LiMn_{0.6}Fe_{0.4}PO₄ |
| Al 1% | C/LiMn_{0.59}Fe_{0.4}Al_{0.01}PO₄ |
| Al 10% | C/LiMn_{0.5}Fe_{0.4}Al_{0.1}PO₄ |

### <XRD>

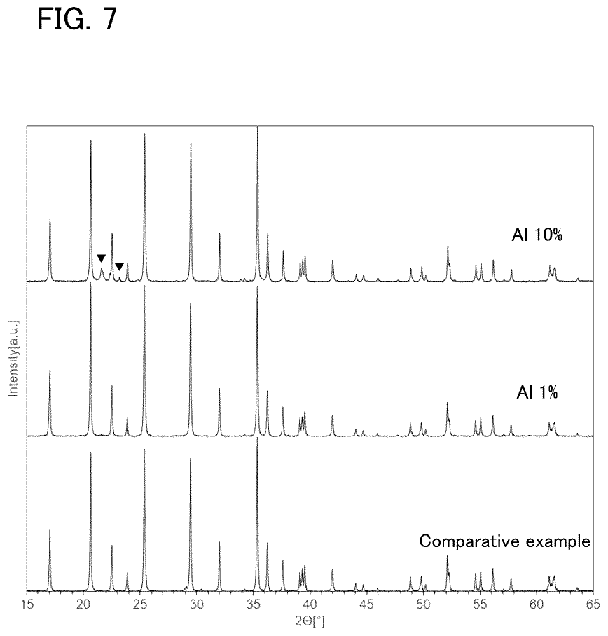

The three samples fabricated in the above manner were subjected to XRD measurement and Rietveld analysis. The XRD apparatus and the measurement conditions were as described in Embodiment 1. FIG. 7 shows XRD patterns of the three samples. The horizontal axis represents 2θ (°) and the vertical axis represents intensity (arbitrary unit). As shown by black inverse triangles in FIG. 7, peaks derived from different phases at diffraction angles of 21.6° and 23.2° were observed in the Al 10%.

Table 2 shows the results of the Rietveld analysis, which is performed precisely on the assumption that the patterns are each a single phase of LiFePO₄ (ICSD coll. code. 193640).

TABLE 2

| | Comparative example | Al 1% | Al 10% |
|---|---|---|---|
| Phase name | LiFePO₄ | LiFePO₄ | LiFePO₄ |
| R-Bragg | 8.382 | 11.541 | 10.155 |
| Space group | Pnma | Pnma | Pnma |
| Scale | 0.001031(2) | 0.001130(3) | 0.001343(4) |
| Cell mass | 631.029 | 631.029 | 631.029 |
| Cell volume (Å³) | 297.741(7) | 297.702(9) | 297.201(10) |
| Wt % - Rietveld | 100 | 100 | 100 |
| Double-Voigt\|Approach | | | |
| Cry size Lorentzian | 125.7(6) | 116.3(7) | 119.1(8) |
| k: 1 LVol-IB (nm) | 80.0(4) | 74.0(4) | 75.8(5) |
| k: 0.89 LVol-FWHM (nm) | 111.9(6) | 103.5(6) | 106.0(7) |
| Crystal Linear Absorption Coeff. (1/cm) | 444.010(11) | 444.067(13) | 444.816(15) |
| Density of crystal (g/cm³) | 3.51934(8) | 3.51979(11) | 3.52573(12) |
| Lattice parameter | | | |
| a (Å) | 10.40098(14) | 10.40024(18) | 10.3948(2) |
| b (Å) | 6.06226(8) | 6.06187(10) | 6.05785(11) |
| c (Å) | 4.72204(7) | 4.72207(9) | 4.71972(10) |
| GOF | 2.26 | 2.91 | 3.67 |

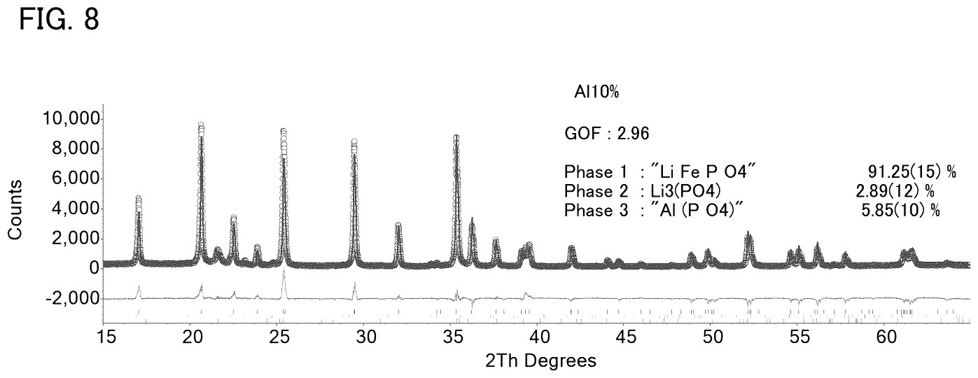

FIG. 8 shows fitting of a pattern of the Al 10%, which is obtained by performing the Rietveld analysis using not only LiFePO₄ but also Li₃PO₄ (ICSD coll. code. 50058) and AlPO₄ (ICSD coll. code. 98378). The horizontal axis represents 2θ (°) and the vertical axis represents intensity (counts). The measured values are denoted by circles and the fitting results are denoted by solid lines. As shown in FIG. 8, the observed heterogeneous phases were derived from lithium phosphate and aluminum phosphate. These results reveal that part of aluminum does not form a solid solution in the olivine crystal structure and exists as aluminum phosphate.

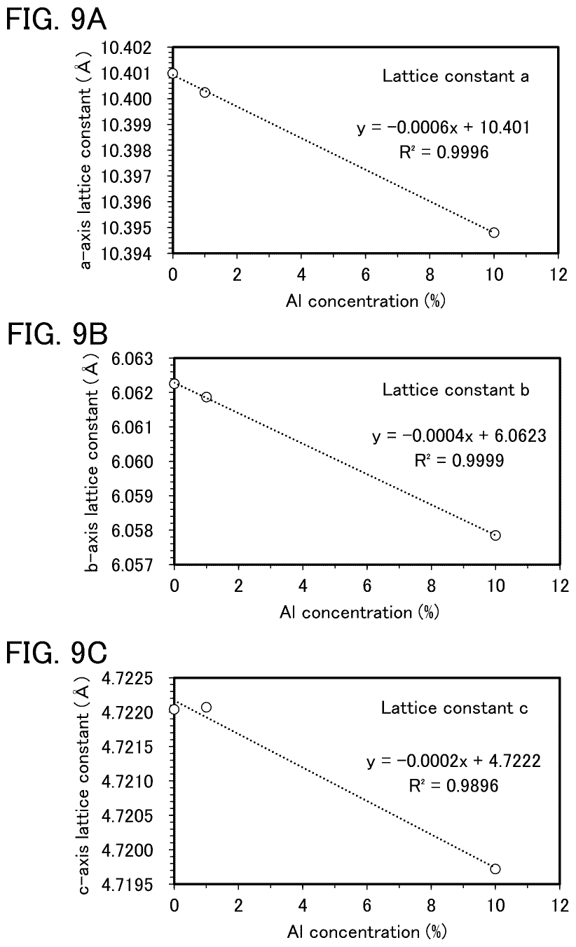

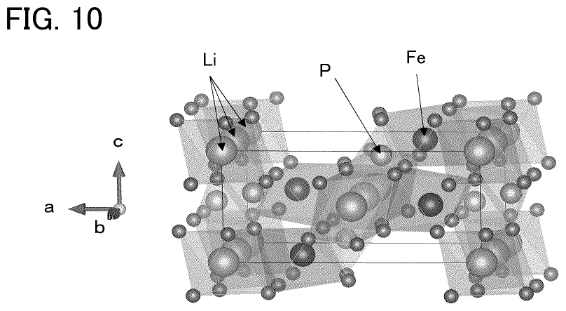

FIGS. 9A to 9C are graphs showing a relation between an aluminum concentration of each sample and a change in a lattice constant of a unit cell obtained from the above analysis. FIG. 9A is a graph of an a-axis lattice constant (Lattice constant a) and the aluminum concentration, FIG. 9B is a graph of a b-axis lattice constant (Lattice constant b) and the aluminum concentration, and FIG. 9C is a graph of a c-axis lattice constant (Lattice constant c) and the aluminum concentration. FIG. 10 shows a unit cell of LiFePO₄ having an olivine crystal structure of a space group Pnma. As shown in FIG. 10, lithium diffusion paths exist in the b-axis direction.

As shown in FIGS. 9A to 9C, the higher the aluminum concentrations are, the smaller the lattice constants and the unit cells tend to be. In particular, the lattice constants on the a-axis and the b-axis were shrunk. Furthermore, the shrunken lattice constants were linear in accordance with the Vegard's law. This indicates that at least part of aluminum forms a solid solution in the olivine crystal structure. The a-axis lattice constant of the sample Al 1% was greater than or equal to 10.3935 Å and less than or equal to 10.4006 Å, or more specifically, greater than or equal to 10.3999 Å and less than or equal to 10.4006 Å. The b-axis lattice constant was greater than or equal to 6.0565 Å and less than or equal to 6.0621 Å, or more specifically, greater than or equal to 6.0616 Å and less than or equal to 6.0621 Å. The c-axis lattice constant was greater than or equal to 4.7218 Å and less than or equal to 4.7221 Å.

As shown in Table 2, the sample Al 1% has a crystallite size LVol-IB of greater than or equal to 50 nm and less than 90 nm, or specifically, 74 nm.

### <Charge and Discharge Characteristics>

With the use of the three samples of the positive electrode active materials formed in the above and a lithium metal for a negative electrode, coin cells (CR2032 type with a diameter of 20 mm and a height of 3.2 mm) (hereinafter also referred to as half cells) were fabricated, and the characteristics thereof were evaluated.

As a separator, polypropylene was used. The electrolyte solution and the electrolyte were each formed by adding 2 wt % of VC to EC: DEC=3:7 (volume ratio) including 1 mol/dm³ of LiPF₆.

Acetylene black was used as the conductive additive, and PVDF was used as the binder. A positive electrode active material, acetylene black, a binder, and NMP as a solvent were mixed to form a slurry. At this time, the weight ratio of the positive electrode active material, the conductive additive, and the PVDF was 90:5:5.

For the positive electrode current collector, aluminum foil coated with carbon was used, and the slurry was applied to the positive electrode current collector. The loading amount of the positive electrode active material was 5 mg/cm². After drying, pressing was performed at 210 kN/m and 120° C.

A rate characteristic test was performed by CCCV charge (constant current and constant voltage) (charge current of 34 mA/g, charge voltage of 4.5 V, and termination current of 3.4 mA/g) and CC discharge (termination voltage of 2.5 V and given discharge current), with a break between the charge and the discharge for 10 minutes. The given discharge current was set in the order of 34 mA/g (0.2 C), 34 mA/g (0.2 C), 34 mA/g (0.2 C), 85 mA/g (0.5 C), 170 mA/g (1 C), 340 mA/g (2 C), 510 mA/g (3 C), 680 mA/g (4 C), 850 mA/g (5 C), and 34 mA/g (0.2 C). The measurement environment temperature was 25° C. Note that n was 2.

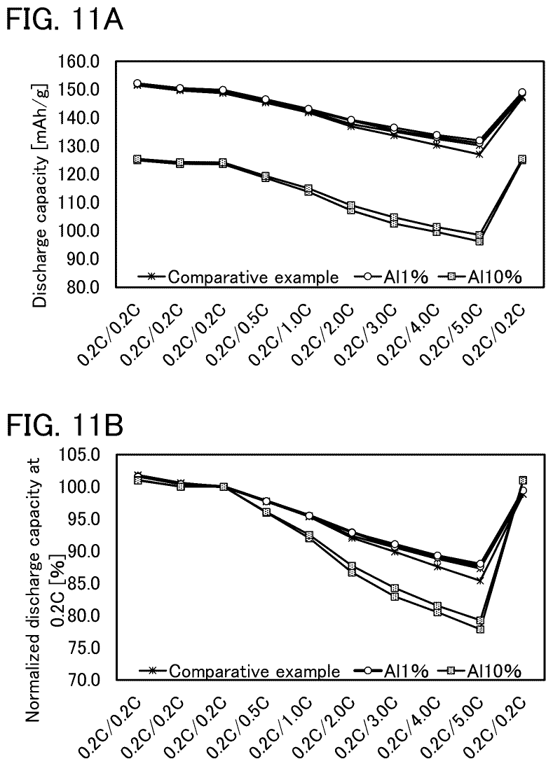

FIG. 11A shows the results of the rate characteristic test. The horizontal axis represents a charge rate/discharge rate and the vertical axis represents a discharge capacity per weight of the positive electrode active material coated with carbon. FIG. 11B shows a normalized discharge capacity ratio with a discharge capacity of the third 0.2 C charge and discharge being 1. As shown in FIG. 11A and FIG. 11B, in the cell including the Al 1% positive electrode active material, a decrease in discharge capacity at a high rate was inhibited and the ratio of a discharge capacity in a 0.2 C discharge test to a discharge capacity in a 5 C discharge test was higher than or equal to 88%. The difference in the discharge capacity between the 0.2 C discharge test and the 5C discharge test was less than or equal to 18.5 mA/g.

Charge and discharge cycle tests were performed by CCCV charge (4.5 V, 85 mA/g, and termination current of 8.5 mA/g) and CC discharge (85 mA/g and termination voltage of 2.5 V) with a break between the charge and the discharge for 10 minutes. The measurement environment temperatures were 25° C., 60° C., and −20° C.

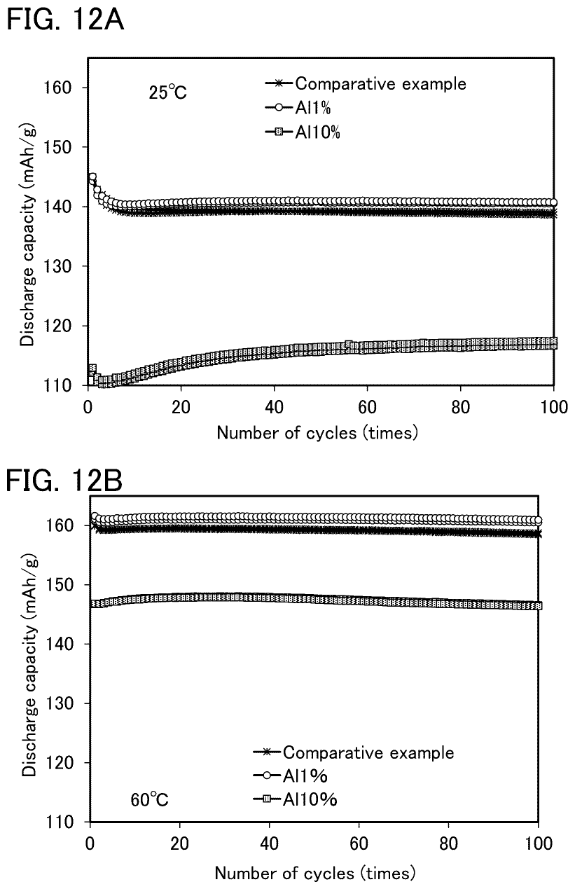

FIG. 12A shows the results of the charge and discharge cycle tests in a measurement environment at 25° C. The horizontal axis represents the number of cycles and the vertical axis represents the discharge capacity per weight of the positive electrode active material coated with carbon. The cell including the Al 1% positive electrode active material had higher discharge capacity than the comparative example and exhibited favorable charge and discharge cycle performance. For example, the discharge capacity per weight of the positive electrode active material was kept higher than or equal to 140 mAh/g even after 100 cycles.

The cell including the Al 1% positive electrode active material showed less decrease in discharge capacity from the 1st cycle to the 20th cycle than the comparative example. Specifically, differences in the discharge capacities of the comparative example between the 1st cycle and the 20th cycle were 6 mAh/g and 5.6 mAh/g, whereas differences in the discharge capacities of the A1 1% between the 1st cycle and the 20th cycle were 3.7 mAh/g and 4.3 mAh/g.

FIG. 12B shows the results of the charge and discharge cycle tests in a measurement environment at 60° C. The horizontal axis represents the number of cycles and the vertical axis represents the discharge capacity per weight of the positive electrode active material coated with carbon. The cell including the Al 1% positive electrode active material had higher discharge capacity than the comparative example and exhibited favorable charge and discharge cycle performance. Furthermore, the cell including the Al 1% had higher discharge capacity at 60° C. than that at 25° C. For example, the discharge capacity per weight of the positive electrode active material was kept higher than or equal to 160 mAh/g from the 1st cycle to the 30th cycle.

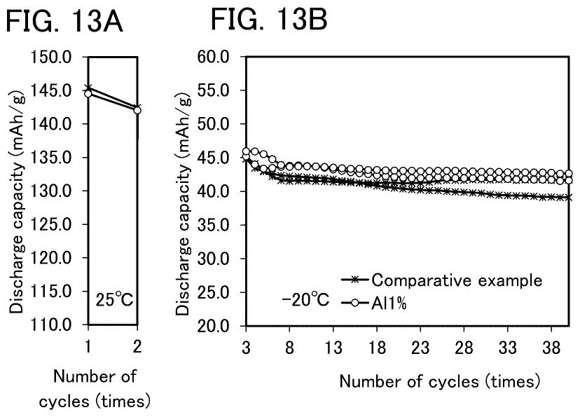

The charge and discharge cycle test in a measurement environment at −20° C. was performed after two cycles of charge and discharge were performed at 25° C. as aging treatment. FIG. 13A and FIG. 13B show the results of the charge and discharge cycle tests in a measurement environment at −20° C. In each graph, the horizontal axis represents the number of cycles and the vertical axis represents the discharge capacity per weight of the positive electrode active material coated with carbon. FIG. 13A shows the discharge capacity after two cycles of charge and discharge were performed at 25° C. as aging treatment, and FIG. 13B shows the discharge capacity measured in a measurement environment at −20° C. after the aging treatment. The range of values on the horizontal axis is different between FIG. 13A and FIG. 13B, but the same cells are denoted by common markers. FIG. 13B shows the number of cycles including two cycles for the aging treatment. Although the discharge capacity at −20° C. was unstable compared with those at 25° C. and 60° C., the Al 1% tended to have higher discharge capacity than that of the comparative example even at −20° C.

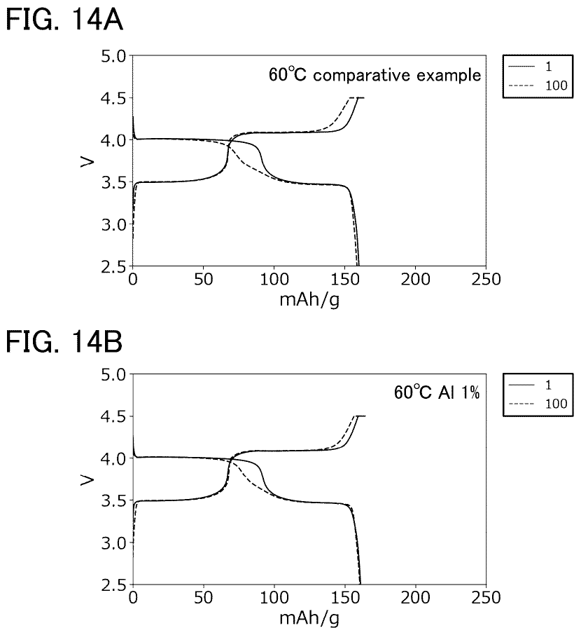

For comparison of a plateau derived from oxidation-reduction of manganese between the comparative example and the Al 1% at 60° C., FIGS. 14A and 14B show charge and discharge curves of a half cell including the comparative example and a half cell including the Al 1% positive electrode active material. In each graph, the 1st cycle is denoted by a solid line and the 100th cycle is denoted by a dotted line. For clarity of the graphs, n was 1.

As shown in FIGS. 14A and 14B, after the charge and discharge cycles, the comparative example exhibited a significant reduction in the amount of plateau derived from oxidation-reduction of manganese while the decrease was inhibited in the Al 1%.

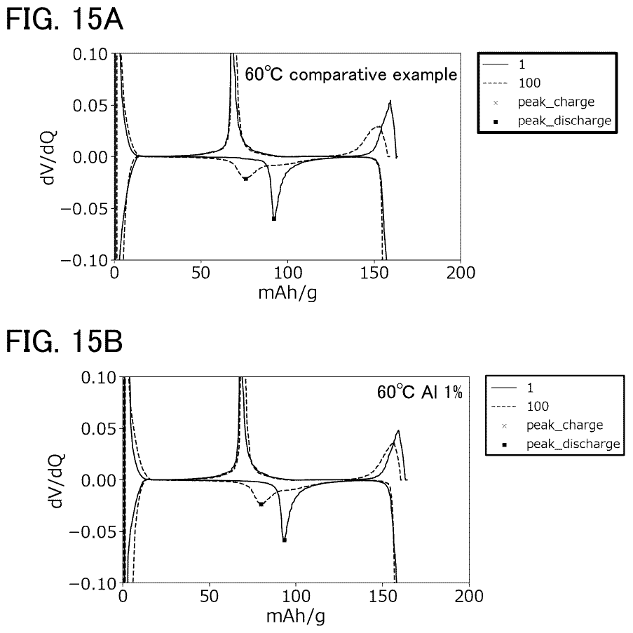

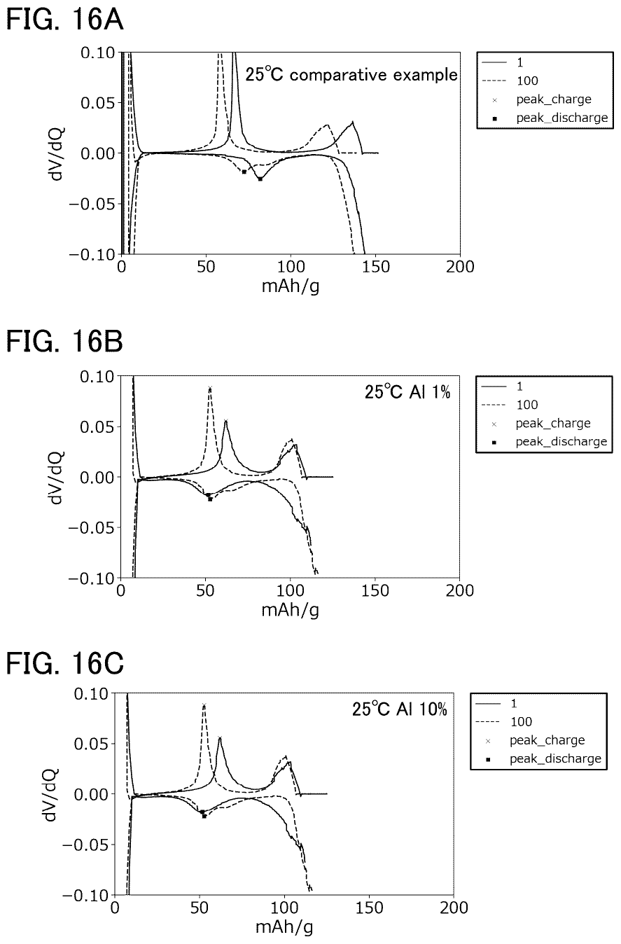

FIGS. 15A to 15C and FIG. 16A to FIG. 16C show discharge dV/dQ curves in the 1st cycle and the 100th cycle of discharge curves at 60° C. and 25° C. For clarity of the graphs, n was 1. FIG. 15A shows a discharge dV/dQ curve of the comparative example at 60° C., FIG. 15B shows a discharge dV/dQ curve of the Al 1% at 60° C., FIG. 16A shows a discharge dV/dQ curve of the comparative example at 25° C., FIG. 16B shows a discharge dV/dQ curve of the Al 1% at 25° C., and FIG. 16C shows a discharge dV/dQ curve of the Al 10% at 25° C. In each graph, the horizontal axis represents charge and discharge capacity and the vertical axis represents dQ/dV.

To quantify a reduction in the amount of plateau derived from oxidation-reduction of manganese, discharge dV/dQ curves in the 1st cycle, the 10th cycle, and the 100th cycle of discharge curves at 60° C. were calculated. The discharge dV/dQ curves were calculated by the method described in Embodiment 1, and the number of averaging processes was 8. Table 3 shows the values of peaks appearing in the discharge dV/dQ curves in the range from 25 mAh/g to 125 mAh/g. The peaks in the discharge dV/dQ curves in the range from 25 mAh/g to 125 mAh/g represent the timing of transition from a plateau derived from oxidation-reduction of manganese to a plateau derived from iron. It can be said that the plateau derived from oxidation-reduction of manganese is maintained as the peaks appear on the higher capacity side.

Table 3 also shows Peak (1)-Peak (100), which is a difference in discharge capacity between Peak (1) at the position where the peak of the discharge dV/dQ curve in the 1st cycle appears and Peak (100) at the position where the peak of the discharge dV/dQ curve in the 100th cycle appears.

TABLE 3

| | | | Dischage dV/dQ peak (mAh/g) | | | |
|---|---|---|---|---|---|---|
| | | | Comparative example | | Al 1% | |
| 60° C. | 1 | cyc | 92.1 | 92.2 | 93.2 | 93.4 |
| | 10 | cyc | 91.7 | 92 | 92.9 | 93.1 |
| | 100 | cyc | 75.8 | 75.5 | 79.9 | 79.9 |

| | | | | |
|---|---|---|---|---|
| Peak(1) − Peak(100) | 16.3 | 16.7 | 13.3 | 13.6 |

As in the case of 60° C., discharge dV/dQ curves in the 1st cycle, the 10th cycle, and the 100th cycle of discharge curves at 25° C. were calculated. Table 4 shows the values of peaks appearing in the discharge dV/dQ curves in the range from 25 mAh/g to 125 mAh/g. Table 4 also shows Peak (1)-Peak (100), which is a difference in discharge capacity between Peak (1) at the position where the peak of the discharge dV/dQ curve in the 1st cycle appears and Peak (100) at the position where the peak of the discharge dV/dQ curve in the 100th cycle appears.

TABLE 4

| | | Dischage dV/dQ peak (mAh/g) | | | | | |
|---|---|---|---|---|---|---|---|
| | | Comparative example | | Al 1% | | Al 10% | |
| 25° C. | 1 cyc | 81.8 | 81 | 81.3 | 81 | 51.4 | 51.2 |
| | 10 cyc | 77.6 | 78.7 | 77.8 | 78.1 | 55.3 | 54.4 |
| | 100 cyc | 72.2 | 68.8 | 75.4 | 75.2 | 52.5 | 53.9 |
| | Peak(1)- | 9.6 | 12.2 | 5.8 | 5.8 | −1.1 | −2.8 |
| | Peak(100) | | | | | | |

As shown in Table 3, Table 4, FIGS. 14A and 14B, FIGS. 15A and 15B, and FIG. 16A to 16C, the peak position of the discharge dV/dQ curve in the range from 25 mAh/g to 125 mAh/g shifted significantly to the lower capacitance side with an increase in charge and discharge cycles in the half cells in which the amount of plateau derived from oxidation-reduction of manganese was reduced. Conversely, the peak position shifted insignificantly in the half cells in which a reduction in the amount of plateau derived from oxidation-reduction of manganese is inhibited. This was probably because a volume change between before and after insertion and extraction of lithium was suppressed by aluminum.

More specifically, when the measurement was performed at 60° C., Peak (1)-Peak (100) was less than or equal to 15 mAh/g in Al 1% in which the reduction in the amount of plateau was inhibited. When the measurement was performed at 25° C., Peak (1)-Peak (100) was less than or equal to 7 mAh/g.

This application is based on Japanese Patent Application Serial No. 2024-108914 filed with Japan Patent Office on Jul. 5, 2024, the entire contents of which are hereby incorporated by reference.

What is claimed is:

1. A lithium-ion secondary battery comprising:
a positive electrode, a negative electrode, and a first electrolyte solution,
wherein the positive electrode comprises a positive electrode active material,
wherein the positive electrode active material comprises an olivine crystal structure,
wherein the positive electrode active material comprises lithium, manganese, iron, aluminum, phosphorus, and oxygen,
wherein an atomic ratio of manganese to the sum of manganese, iron, and aluminum (Mn/(Mn+Fe+Al)) in the positive electrode active material is greater than 0.5 and less than 0.85, and
wherein an atomic ratio of aluminum to the sum of manganese, iron, and aluminum (Al/(Mn+Fe+Al)) in the positive electrode active material is greater than or equal to 0.01 and less than 0.1.

2. The lithium-ion secondary battery according to claim 1,
wherein the olivine crystal structure belongs to a space group Pnma (No. 62), and
wherein when a powder X-ray diffraction pattern of the positive electrode is subjected to Rietveld analysis with CuKα₁ radiation,
an a-axis lattice constant of the olivine crystal structure is greater than or equal to 10.3935 Å and less than or equal to 10.4006 Å,
a b-axis lattice constant of the olivine crystal structure is greater than or equal to 6.0565 Å and less than or equal to 6.0621 Å, and
a c-axis lattice constant of the olivine crystal structure is greater than or equal to 4.7218 Å and less than or equal to 4.7221 Å.

3. The lithium-ion secondary battery according to claim 2,
wherein a crystallite size LVol-IB of the olivine crystal structure is greater than or equal to 50 nm and less than 90 nm.

4. The lithium-ion secondary battery according to claim 1,
wherein when a half cell comprising the positive electrode and a second electrolyte solution comprising ethylene carbonate, diethyl carbonate, and vinylene carbonate is subjected to a charge and discharge cycle test in a measurement environment at 60° C.,
a discharge capacity per weight of the positive electrode active material is greater than or equal to 160 mAh/g in the first cycle to the 30th cycle, and
wherein in the charge and discharge cycle test,
CCCV with a charge current of 85 mA/g, a charge voltage of 4.5 V, and a termination current of 8.5 mA/g, and CC discharge with a discharge current of 85 mA/g and a termination voltage of 2.5 V are performed in this order.
